(19) United States
(12) Patent Application Publication
(10) Pub. No.: US 2008/0160419 A1
(43) Pub. Date: Jul. 3, 2008

(54) Electrolyte Solutions For Electrochemical Energy Devices

(76) Inventors: Haruki Segawa, Kanagawa pref. (JP); William M. Lamanna, Stillwater, MN (US); Michael G. Costello, Afton, MN (US)

Correspondence Address: 3M INNOVATIVE PROPERTIES COMPANY, PO BOX 33427, ST. PAUL, MN, 55133-3427, US

(21) Appl. No.: 11/815,117

(22) PCT Filed: Feb. 3, 2006
(86) PCT No.: PCT/US06/03782

§ 371 Date: Jul. 31, 2007

(30) Foreign Application Priority Data
Feb. 3, 2005 (JP) 2005-027641

(51) Int. Cl. H01M 10/40

(52) U.S. Cl. 429/331; 429/330; 429/333; 429/332

(57) ABSTRACT

Electrolyte solutions for an electrochemical energy device, including a lithium secondary battery, comprising (a) a supporting electrolyte salt and (b) a solvent composition comprising (1) at least one of a cyclic carbonic acid ester solvent and (2) at least one fluorine-containing solvent having a boiling point of at least 80° C., selected from among the following chemical formulas (i) to (iii): (i) R₁—O—R_{f1}; (ii) R₂—O—(R_{f2}—O)ₚ—(R_{f3}—O)_{q}—R₃; (iii) A—(O—R_{f4})ₘ (where the definition of each formula is as described in the claim)

### FIELD

The present invention relates to electrolyte solutions for electrochemical energy devices.

### BACKGROUND

Electrochemical energy devices can be made in a variety of capacities and types. For example, devices where the charging or discharging voltage of a unit cell exceeds 1.5 V include lithium primary batteries, lithium secondary batteries, lithium ion secondary batteries, lithium ion gel polymer batteries (sometimes called lithium polymer batteries or lithium ion polymer batteries) and high-voltage electric double layer capacitors (those where the voltage at charging exceeds 1.5 V). Water cannot generally be used as a solvent for an electrolytic or electrolyte solution used in such high-voltage electrochemical energy devices, because hydrogen and oxygen are generated as a result of electrolysis. Therefore, a non-aqueous electrolytic solution obtained by dissolving a supporting electrolyte salt in an aprotic solvent such as an alkyl carbonate or an alkyl ether is generally used. Furthermore, even in devices where the voltage does not exceed 1.5 V, where a negative electrode (anode) that utilizes the intercalation or alloying or plating of lithium is employed, the active lithium species in such an electrode can readily react with water and, therefore, a non-aqueous electrolyte solution must be used.

Various fluorine-containing solvents have been added to nonaqueous electrolytes to form nonaqueous electrolyte solutions, with the aim of improving characteristics relating to battery safety such as fire resistance, or characteristics relating to battery function such as low temperature or cycle characteristics. However, as explained below, technology so far has achieved only limited improvement in some characteristics while sacrificing other properties, and it has been difficult to realize a practical battery from a comprehensive viewpoint.

Japanese Unexamined Patent Publication No. 2001-85058 discloses a way of improving the low temperature or high load characteristics of nonaqueous electrolyte batteries by combining a specific fluorinated solvent with the nonaqueous electrolyte solution. However, the fluorinated solvent disclosed in this document is not restricted in its boiling point, and numerous compounds are encompassed which tend to cause deterioration in the characteristics of the battery at high temperatures. For example, the most representative examples of the compounds mentioned in the disclosure are 1,1,2,3,3,3-hexafluoropropylmethyl ether and nonafluorobutylmethyl ether, but their boiling points of 53° C. and 61° C., respectively, are excessively low. Such compounds are detrimental at high temperatures, because vaporization of the solvent causes an increase in internal battery pressure and a deterioration in battery characteristics.

Denki Kagaku Oyobi Kogyo Butsuri Kagaku, Vol. 71, No. 12, 1067-1069 (2003) reports the usage of ethylmonofluorobutyl ether (“EFE”) for rendering a nonaqueous electrolyte noncombustible. Although EFE alone is a noncombustible liquid, ignition can occur in solvent mixtures of EFE and other commonly used co-solvents such as diethyl carbonate (“DEC”) having EFE concentrations as high as about 60-80 vol %.

Batteries using metallic lithium as a negative electrode have long been investigated as secondary batteries having high energy density. The major problem with using metal lithium for the negative electrode is that the reversibility of lithium deposition/dissolution with charge/discharge is not satisfactory for the purpose of manufacturing a practical secondary battery. Specifically, generation of lithium dendrites during repeated charge/discharge cycles results in formation of inactive lithium or internal shorting of the cell.

Japanese Unexamined Patent Publications HEI No. 11-26016, HEI No. 11-2601, HEI No. 11-31528, and No. 2001-6733 disclose the use of a typical lithium imide salt, LiBETI, as a supporting electrolyte and a cyclic ether such as tetrahydrofuran (“THF”) or tetrahydropyran (“THP”) as a solvent to provide metallic lithium secondary batteries with reportedly high cycle efficiency. In some of these disclosures it is stated that other components (for example, dioxane) may be added as solvent components, but the use of a large amount of cyclic ether such as THF or THP is common to all of them. The flash points of THF and THP are, however, −17° C. and −15° C., respectively, and therefore nonaqueous electrolyte solutions using them are readily susceptible to ignition.

### SUMMARY OF THE INVENTION

There remains in the industry a need for electrolyte solutions for electrochemical energy devices, including lithium secondary batteries, that are fire resistant and exhibit improved safety characteristics; that exhibit improved performance including high charge/discharge rate capability at ambient and low temperatures; and for which such safety and performance advantages are not attained at the expense of other required characteristics of the device. There is also a need for electrochemical energy devices with improved electrode charge/discharge cycling efficiencies and prolonged device lifetimes.

According to one aspect, the present invention provides an electrolyte solution for an electrochemical energy device. The solution generally comprises:
(a) a supporting electrolyte salt; and
(b) a solvent composition comprising: (1) at least one cyclic carbonic acid ester solvent; and (2) at least one fluorine-containing solvent having a boiling point of at least 80° C. and selected from among the following chemical formulas (i) to (iii):
   (i) R₁—O—R_{f1}
      where R₁ represents a linear, branched or cyclic C₁-C₁₂ alkyl, aryl or alkenyl group; and R_{f1} represents an at least partially fluorinated linear, branched or cyclic C₅-C₁₂ alkyl, aryl or alkenyl group that may optionally further contain one or more ether-bound oxygen atoms provided that where R_{f1} contains one or more oxygen atoms it contains at most two hydrogen atoms; with the proviso that when the solvent composition comprises only a fluorine containing solvent of the formula (i) the solvent composition does not also contain difluoroethylene carbonate;
   (ii) R₂—O—(R_{f2}—O)ₚ—(R_{f3}—O)₁—R₃
      where R₂ and R₃ each independently represent a linear or branched, non- or partially fluorinated C₁-C₁₂ alkyl group; R_{f2} and R_{f3} each independently represent a linear, branched or cyclic C₁-C₁₀ fluorinated alkylene group; and p and q are independently 0 or an integer from 1-10 with the proviso that p and q are not both 0 at the same time; and
   (iii) A—(O—R_{f4})ₘ
      where each R_{f4} independently represents an at least partially fluorinated linear, branched or cyclic C₂-C₉ alkyl, aryl or alkenyl group that may optionally include one or more ether-bound oxygen atoms and/or a halogen atom other than fluorine; A is a C₁-C₈ di- to tetravalent linear, branched or cyclic hydrocarbon group that may optionally contain one or more ether-bound oxygen atoms; and m is an integer from 2-4 with the proviso that when m is 2 then R_{f4} is perfluorinated or A is non-linear or both R_{f4} is perfluorinated and A is non-linear;
         wherein said (a) supporting electrolyte salt is present in an amount of about 0.1-2 mol per liter of said (b) solvent composition, and said (b) solvent composition contains said (1) cyclic carbonic acid ester solvent at greater than 0 and less than about 90 vol % and said (2) fluorine-containing solvent at greater than 0 and no greater than about 80 vol %.

In other aspects, the invention provides electrochemical energy devices, including secondary lithium batteries, employing electrolyte solutions such as those described above. Such electrochemical energy devices can be made to be fire resistant and exhibit improved performance including improved charge/discharge rate capability at ambient and low temperatures. The electrochemical energy devices of the invention can also exhibit improved electrode charge/discharge efficiencies and prolonged device lifetimes.

### BRIEF DESCRIPTION OF THE DRAWINGS

FIG. 1 is a graph showing solvent component compositions and lithium salt solubilities for examples of the invention.

FIG. 2 is a graph showing solvent component compositions and lithium salt solubilities for examples of the invention.

FIG. 3 is a graph showing solvent component compositions and lithium salt solubilities for examples of the invention.

FIG. 4 is a graph showing solvent component compositions and lithium salt solubilities for examples of the invention.

FIG. 5 is a graph showing solvent component compositions and lithium salt solubilities for examples of the invention.

FIG. 6 is a graph showing solvent component compositions and lithium salt solubilities for examples of the invention.

FIG. 7 is a graph showing solvent component compositions and lithium salt solubilities for examples of the invention.

FIG. 8 is a graph showing solvent component compositions and lithium salt solubilities for examples of the invention.

FIG. 9 is a graph showing solvent component compositions and lithium salt solubilities for examples of the invention.

FIG. 10 is a graph showing solvent component compositions and lithium salt solubilities for examples of the invention.

FIG. 11 is a graph showing solvent component compositions and lithium salt solubilities for examples of the invention.

FIG. 12 is a graph showing solvent component compositions and lithium salt solubilities for examples of the invention.

FIG. 13 is a graph showing solvent component compositions and lithium salt solubilities for examples of the invention.

FIG. 14 is a graph showing solvent component compositions and lithium salt solubilities for examples of the invention.

FIG. 15 is a graph showing solvent component compositions and lithium salt solubilities for examples of the invention.

FIG. 16 is a graph showing solvent component compositions and lithium salt solubilities for examples of the invention.

FIG. 17 is a graph showing solvent component compositions and lithium salt solubilities for examples of the invention.

FIG. 18 is a graph showing cell potential profiles during lithium ion intercalation.

FIG. 19 is a graph showing cell potential profiles during lithium ion intercalation.

FIG. 20 is a graph showing battery discharge capacity with respect to charge/discharge cycle.

FIG. 21 is a graph showing battery discharge capacity with respect to charge/discharge cycle.

FIG. 22 is a graph showing battery discharge capacity with respect to charge/discharge cycle.

FIG. 23 is a graph showing battery discharge capacity with respect to charge/discharge cycle.

### DETAILED DESCRIPTION OF ILLUSTRATIVE EMBODIMENTS

Illustrative embodiments of the invention will now be described with the understanding that the invention is not to be limited to the embodiments used for such illustrative purposes.

The electrolyte solutions of the present invention are useful in electrochemical energy devices, including batteries, cells, double-layer capacitors, etc. (hereinafter sometimes simply referred to as devices). The solutions comprise a supporting electrolyte salt and a solvent composition. For lithium or lithium ion batteries, the supporting electrolyte salt will preferably be or include a lithium salt. The solvent composition comprises at least one cyclic carbonic acid ester solvent and at least one fluorinated solvent having a boiling point of 80° C. or higher. When the electrolyte solutions of the invention are used in an electrochemical energy device, for example in a lithium primary battery, a lithium secondary battery, a lithium ion gel polymer batter (generally called a lithium polymer battery, and sometimes called a lithium ion polymer battery) or a high-voltage electric double layer capacitor (particularly those where the voltage at charging exceeds 1.5 V), good high current discharging performance can be obtained and the device can be resistant to damage at high temperatures. More specifically, by employing the solvent compositions of the invention (as illustrated more fully herein) generation of high internal pressures can be prevented upon exposure of the device to high temperatures. The solvent compositions of the invention can furthermore provide high charge/discharge rate capability at ambient and low temperatures. Additionally, fire resistance may be imparted to the device, and cycling performance may be enhanced.

The electrolyte solutions of the invention generally comprise a supporting electrolyte salt and a solvent composition that comprises at least one cyclic carbonic acid ester solvent and at least one fluorine-containing solvent having a boiling point of 80° C. or higher.

For use in lithium or lithium ion batteries or other electrochemical energy devices employing lithium or lithium ions, the supporting electrolyte salt may be an organic lithium salt, an inorganic lithium salt or a mixture thereof. Organic lithium salts include lithium organic sulfonylimide salts such as lithium bis(pentafluoroethanesulfonyl)imide (FLUORAD FC-130, available from 3M Company, or FLUORAD 13858, available from Sumitomo 3M Co., Ltd.) (LiBETI), lithium bis(trifluoromethanesulfonyl)imide (FLUORAD HQ-115, available from 3M Company, or HQ-115J, available from Sumitomo 3M Co., Ltd.) (LiTFSI) and bis(nonafluorobutanesulfonyl)imide (LiDBI), or lithium organic sulfonylmethide salts such as lithium tris(trifluoromethanesulfonyl)methide (LiTFM), or lithium organic sulfonate salts such as lithium triflate (LiO₃SCF₃), or lithium organic borate salts such as lithum bis-oxalatoborate (Li-BOB). Inorganic salts include lithium hexafluorophosphate (LiPF₆) as well as LiBF₄, LiClO₄, LiAsF₆ and the like. These organic and inorganic salts may also be used in mixtures of more than one type, or a mixture of an inorganic salt and an organic salt may also be used. A lithium organic salt has high solubility in the solvent composition and can form high-concentration electrolyte salt solutions. Consequently, a cyclic carbonic acid ester solvent and a fluorine-containing ether solvent may be the only solvent components used. On the other hand, inorganic lithium salts such as lithium hexafluorophosphate (LiPF₆) are generally less expensive than organic lithium salts but are poorly soluble in certain solvent compositions. When the lithium salt supporting electrolyte contains an inorganic salt, therefore, the solvent components may, in some cases, further include an aprotic organic solvent other than a cyclic carbonic acid ester in addition to the cyclic carbonic acid ester solvent and the fluorine-containing ether solvent.

The concentration of the lithium salt will usually be in the range of 0.1-2 mol per liter (mol/L) of the solvent composition, preferably around 1.0 mol/L. The lithium salt may consist of an organic lithium salt alone, an inorganic lithium salt alone or a mixture thereof.

The solvent compositions of the invention include at least one cyclic carbonic acid ester solvent. Useful cyclic carbonic acid ester solvents may be fluorinated or non-fluorinated, though mono-fluorinated cyclic carbonic acid ester solvents and non-fluorinated cyclic carbonic acid ester solvents will generally be preferred. In the case where the solvent composition comprises a fluorine-containing solvent of the type described by the formulas (ii) or (iii) below, the solvent composition may include a difluorinated cyclic carbonic acid ester solvent. The cyclic carbonic acid ester may be ethylene carbonate, propylene carbonate, butylene carbonate, vinylene carbonate, vinylethylene carbonate or the like, either alone or in admixture. Since cyclic carbonic acid esters have high dielectric constants, it is thought that they facilitate dissolution of the supporting electrolyte and ion dissociation in the solution. However, cyclic carbonic acid esters are also highly viscous and therefore tend to inhibit migration of dissociated ions in solution. Consequently, the amount of the carbonic acid ester solvent may be selected based on the type and concentration of the supporting electrolyte, and on the temperature of intended use. The amount of the carbonic acid ester solvent will generally be greater than 0 vol % and no greater than 90 vol % based on the total volume of the components of the solvent composition. The amount of the cyclic carbonic acid ester is preferably greater than 0 vol % and no greater than 50 vol %, and more preferably greater than 0 vol % and no greater than 30 vol %.

The solvent compositions of the invention also include at least one fluorine-containing solvent having a boiling point of at least 80° C. or higher and selected from among the following chemical formulas (i) to (iii):
(i) R₁—O—R_{f1}
   where R₁ represents a linear, branched or cyclic C₁-C₁₂ alkyl, aryl or alkenyl group (preferably an alkyl or alkenyl group); and R_{f1} represents an at least partially fluorinated linear, branched or cyclic C₅-C₁₂ alkyl, aryl or alkenyl group (preferably an alkyl or alkenyl group) that may optionally further contain one or more ether-bound oxygen atoms provided that where R_{f1} contains one or more oxygen atoms it contains at most two hydrogen atoms; with the proviso that when the solvent composition comprises only a fluorine containing solvent of the formula (i) the solvent composition does not also contain difluoroethylene carbonate;
(iv) R₂—O—(R_{f2}—O)ₚ—(R_{f3}—O)_{q}—R₃
   where R₂ and R₃ each independently represent a linear or branched, non- or partially fluorinated C₁-C₁₂ alkyl group; R_{f2} and R_{f3} each independently represent a linear, branched or cyclic C₁-C₁₀ fluorinated alkylene group; and p and q are independently 0 or an integer from 1-10 with the proviso that p and q are not both 0 at the same time; and
(v) A—(O—R_{f4})ₘ
   where each R_{f4} independently represents an at least partially fluorinated linear, branched or cyclic C₂-C₉ alkyl, aryl or alkenyl group (preferably an alkyl or alkenyl group) that may optionally include one or more ether-bound oxygen atoms and/or a halogen atom other than fluorine; A is a C₁-C₈ di- to tetravalent linear, branched or cyclic hydrocarbon group that may optionally contain one or more ether-bound oxygen atoms; and m is an integer from 2-4 with the proviso that when m is 2 then R_{f4} is perfluorinated or A is non-linear or both R_{f4} is perfluorinated and A is non-linear;

It was discovered that the electrode cycling efficiency can be increased when a fluorine-containing solvent of the type listed above is used in an electrolyte solution of the invention for a lithium secondary battery. The fluorine-containing solvent also increases the fire resistance of the solvent composition. The fire resistance property of a molecule may be correlated to its “halogenation ratio” (or “halogen substitution rate”) which may be expressed as a ratio of the number of halogen atoms to the total number of halogen and hydrogen atoms in the molecule. In other words, the halogenation ratio may be expressed as follows:

$$\frac{\begin{matrix}\# Fluorine Atoms + \\ \# Halogen Atoms Other Than Fluorine \end{matrix}}{\begin{matrix}\# Fluorine Atoms + \\ \# Halogen Atoms Other Than Fluorine + \\ \# Hydrogen Atoms\end{matrix}}$$

To satisfactorily increase the fire resistance of an electrochemical device in which the solvent compositions of the invention are employed, the fluorine-containing solvents of the type above preferably have a halogenation ratio of between about 0.50 and about 0.85, more preferably between about 0.57 and 0.85. While not desiring to be bound by any particular theory, generally if a halogenation ratio is below 0.50 the fire resistant effect is reduced, and if it is greater than 0.85 the compatibility with the structural components of the electrolyte solution other than the fluorine-containing solvent is impaired. Particularly in the case of a fluorine-containing solvent represented by formula (i), the compatibility with other components will often be poor if R_{f1} contains no hydrogen atoms, even if the halogenation ratio rate is 50-85%, and therefore, R_{f1} preferably contains at least one hydrogen atom.

Specific representative examples of useful fluorine-containing solvents include the following: C₆F₁₃—O—CH₃; C₆F₁₃—O—C₂H₅; CH₃—O—C₆FI₂—O—CH₃; CH₃—O—C₃F₆—O—C₃F₆—O—CH₃; CF₃CFHCF₂—O—CH₂CH(CH₃)—O—CF₂CFHCF₃; H(CF₂)₈CH₂—O—CH₃; H(CF₂)₈CH₂—O—CH₃; CF₃CFHCF₂—O—CH₂CH(—O—CF₂CFHCF₃)CH₂—O—CF₂CFHCF₃; C(CH₂—O—CF₂CFHCF₃)₄; CH₃C(CH₂—O—CF₂CFHCF₃)₃; C₄F₉—O—CH₂CH₂—O—C₄F₉; and mixtures thereof.

The fluorine-containing solvent will generally be present in the solvent compositions of the invention in an amount greater than 0 vol % and no greater than 80 vol % based on the total volume of the solvent components.

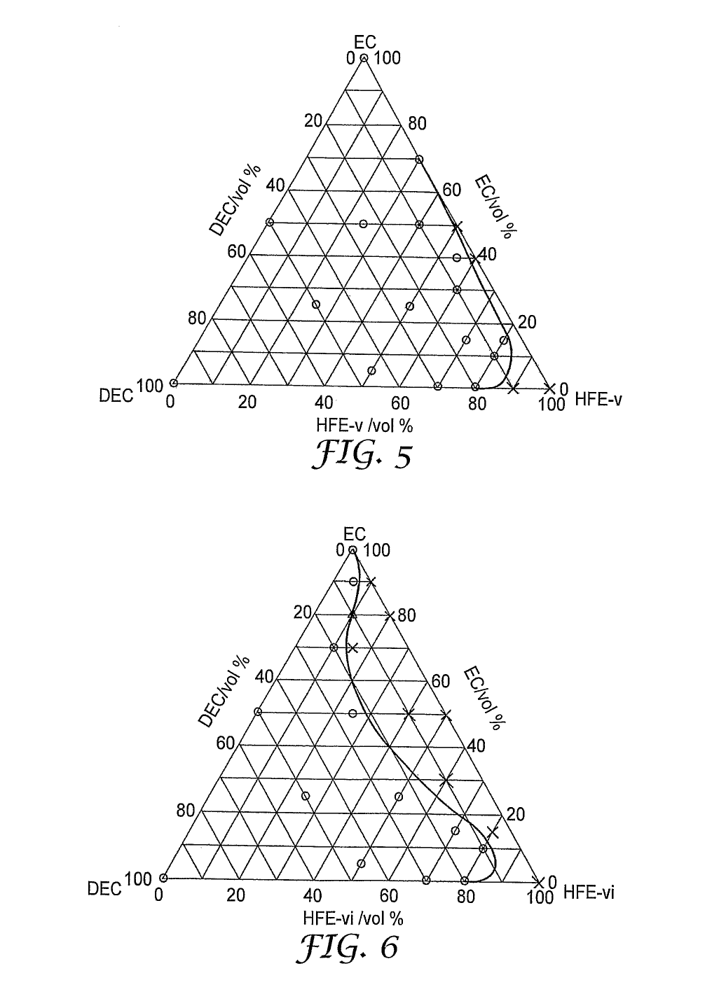

The solvent compositions for the electrolyte solutions of the invention may also optionally include other solvent components, including an aprotic solvent other than a cyclic carbonic acid ester. This solvent may have the effect of increasing the solubility of the supporting electrolyte while lowering the viscosity of the electrolyte solution. When the amount of the fluorine-containing ether solvent component is increased in order to improve the electrochemical device characteristics, it can be advantageous to add an aprotic solvent other than a cyclic carbonic acid ester. For example, when the lithium salt is lithium bis(pentafluoroethanesulfonyl)imide (“LiBETI”) and the solvent consists of the two components ethylene carbonate (“EC”) and H—(CF₂)₆—CH₂—O—CH₃ (“HFE-v”), the maximum solubility of BFE-v is about 40 vol %; however, addition of diethyl carbonate (“DEC”) can produce a stable solution even with HFE-v at 80 vol % (see FIG. 5).

Useful aprotic solvents for this purpose include, specifically, acyclic carbonic acid esters represented by the general formula RₓOCOOR_{y} (where Rₓ and R_{y} are the same or different and each represents a straight-chain, cyclic or branched C₁-C₄ alkyl, aryl or alkenyl group), γ-butyrolactone, 1,2-dimethoxyethane, diglyme, tetraglyme, tetrahydrofuran, alkyl-substituted tetrahydrofuran, 1,3-dioxolane, alkyl-substituted 1,3-dioxolane, tetrahydropyran, alkyl-substituted tetrahydropyran and the like. Useful aprotic solvents may be a single compound or may be a mixture of two or more compounds.

When an inorganic lithium salt is included in an amount of less than 0.1 mol/L as a supporting electrolyte, one or more aprotic solvents other than a cyclic carbonic acid ester may be included at less than 80 vol % as a solvent component, and when an inorganic lithium salt is included at 0.1-2 mol/L as all or part of the lithium salt supporting electrolyte, one or more aprotic solvents other than a cyclic carbonic acid ester may be included at 10 vol % or greater and less than 80 vol % as a solvent component.

While the solvent compositions of the inventions do not require an aprotic solvent other than a cyclic carbonic acid ester, in some cases and for some uses a preferred solvent composition will include at least one cyclic carbonic acid ester, at least one of the aforementioned specific fluorine-containing solvents and at least one aprotic solvent other than the cyclic carbonic acid ester. By including these three components it is possible to improve the compatibility of the electrolyte solution components, and particularly the compatibility with inorganic lithium salts such as LiPF₆. The amount of the fluorine-containing ether may also be increased while maintaining the homogeneity of the solution.

The amount of the fluorine-containing solvent component will generally be no greater than about 80 vol % from the standpoint of compatibility. The fluorine-containing solvent may be present from 0 vol % to no greater than 80 vol % but is preferably present from about 5 vol % to about 75 vol %. If the amount of the fluorine-containing solvent is too low, little or no improvement in the rate capability or low temperature rate characteristics may be achieved. Even if a stable and uniform solution is maintained, an excessive amount of the fluorine-containing solvent can inhibit ion dissociation of the dissolved lithium salt and thus prevent improvement in, and even impair, the rate capability or low temperature rate characteristics of the cell. On the other hand, the cyclic carbonic acid ester is also an essential component and is present at preferably from 0 vol % to no greater than 50 vol %, more preferably no greater than 30 vol % and even more preferably no greater than 15 vol %. In most cases with a electrolyte solution comprising no fluorine-containing solvent, such as EC/DEC, combining the two components in a volume ratio of about 30/70 to 50/50 will increase the ion conductivity and result in excellent battery rate and low temperature characteristics, and therefore such compositions are preferred for use. However, it was surprisingly found that when the electrolyte solution comprises a fluorine-containing solvent according to the invention, improved rate capability and low temperature rate performance is achieved with only a relatively small amount of a cyclic carbonic acid ester (such as EC) present, generally no greater than about 30 vol % or even no greater than about 15 vol %. In addition, from the standpoint of fire resistance the fluorine-containing solvent content is preferably at least 5 vol %, more preferably at least 15 vol % and most preferably at least 20 vol %. These volume percentages are based on the total volume of the solvent composition. The composition of the solvent components may be varied depending on the electrolyte solution and/or the device characteristics to be improved.

The electrolyte solutions of the invention find particular utility in lithium secondary batteries. A lithium secondary battery generally comprises a positive electrode, a negative electrode and an electrolyte solution, and either or both of the active substances used in the positive electrode or negative electrode include substances which undergo lithium deintercalation/intercalation, lithium occlusion/release, lithium deposition/dissolution and/or lithium adsorption/desorption reaction during charge and/or discharge of the battery.

The electrodes used for the battery of the invention are not particularly restricted, but preferably the positive electrode is one which has a potential at full state of charge about 1.5 V or greater and more preferably between about 3.0 V and about 5.0 V, most preferably between about 3.5 V and about 4.6 V with respect to Li/Li⁺. Examples of positive electrodes are those where the positive electrode active substance is a composite metal oxide comprising lithium and one or more transition metal elements. Specific examples include composite oxides of lithium and transition metals having a laminar crystal structure, composite oxides of lithium and metals having a spinel structure, and composite oxides of lithium and metals having an olivine structure, which are represented by LiₐNi_{b}CO_{c}Mn_{d}O₂ (0.8≦a≦1.2, 0≦b≦1, 0≦c≦1, 0≦d≦1). Organic sulfur-based compounds may also be used as the positive electrode active substance.

The negative electrode material is preferably one which has a potential at full state of charge between 0 and about 1.5 V, more preferably between 0 and about 1.0 V versus Li/Li⁺. Examples of negative electrodes are those where the negative electrode active substance is lithium, lithium-containing alloys and various lithiated forms of carbon. Specifically, these include carbon materials such as natural graphite, artificial graphite, hard carbon, mesophase carbon microbeads (“MCMB”) and fibrous graphite, metallic lithium, metals which can alloy with lithium such as aluminum, silicon and tin, or mixtures thereof. Lithium metal is particularly preferred from the standpoint of obtaining a negative electrode material having the maximum theoretical density.

Various other solvent components and additives may be included as components of the electrolyte solutions of the invention in addition to the supporting electrolyte salt, the fluorine-containing solvent, the cyclic carbonic acid ester solvent and the aprotic solvent other than a cyclic carbonic acid ester, preferably in amounts that do not compromise the beneficial effects of the invention. For example, negative electrode modifiers such as vinylene carbonate, ethylene sulfate and propanesultone, or positive electrode modifiers such as biphenyl and cyclohexylbenzene may be added. A polymer may also be added to the nonaqueous electrolyte of the invention and solidified to produce a gel polymer electrolyte.

A lithium secondary battery employing an electrolyte solution of the invention can undergo charging at a high rate. That is, even with charging for a short time with a relatively large current it is possible to achieve useful cell capacity in subsequent discharge. A lithium secondary battery employing an electrolyte solution of the invention also has an excellent high rate discharge characteristic, and the practical run time is thereby extended in cases where discharge occurs at a relatively high rate (large current), as in the case of continuous conversation with a cellular phone, for example. Consequently, in a lithium secondary battery employing an electrolyte solution, positive electrode and negative electrode according to the invention, it is possible to exhibit performance suitable for purposes wherein charge and/or discharge is carried out with a current value of 1.0 CmA or greater as the maximum current value for charge and/or discharge, where CmAh represents the smaller capacity from among the positive electrode capacity and the negative electrode capacity, as calculated from the weight of the electrode active substance.

A lithium secondary battery employing an electrolyte solution of the invention also has excellent low temperature charge/discharge characteristics. That is, it is possible to achieve practical charging capacity even when the charging is conducted at a low temperature without loss during storage and with a prolonged usable life during discharge. In addition, the electrolyte solutions of the invention have high boiling points and excellent stabilities, and therefore the charge/discharge/storage characteristics of the lithium secondary battery are improved at high temperatures. Thus, a lithium secondary battery employing an electrolyte solution of the invention is capable of charge, discharge and/or storage at an environmental temperature of 0° C. and below, or at an environmental temperature of 45° C. and above. Moreover, since electrolyte solutions of the invention exhibit increased charge/discharge efficiency, it is possible to improve the battery cycle life characteristics. That is, a high level of battery capacity is maintained for long periods even after 10 or more repeated charge/discharge cycles.

### EXAMPLES

The present invention will now be explained by examples. The following abbreviations are used throughout the examples.

Ethylene carbonate (“EC”)

Propylene carbonate (“PC”)

Diethyl carbonate (“DEC”)

Ethyl methyl carbonate (“EMC”)

Dimethoxyethane (“DME”)

Tetrahydrofuran (“THF”)

Tetrahydropyran (“THP”)

C₂F₅CF(CF(CF₃)₂—OCH₃ (“HFE-i”)

CF₃CFHCF₂OC₂H₄OCF₂CFHCF₃ (“HFE-ii”)

CF₃CFHCF₂OCH₂CH₂CH₂OCF₂CFHCF₃ (“HFE-iii”)

CH₃—O—C₆F₁₂—O—CH₃ (“HFE-iv”)

H—C₆F₁₂—CH₂—O—CH₃ (“HFE-v”)

H—C₈F₁₆—CH₂—O—CH₃ (“HFE-vi”)

C₃F₇—O—C₂HF₃—O—C₂H₄—O—C₂HF₃—O—C₃F₇ (“HFE-vii”)

C₂HClF₃—O—C₂H₄—O—C₂HClF₃ (“HFE-viii”)

CF₃CFHCF₂—O—CH₂CH(CH₃)—O—CF₂CFHCF₃ (“HFE-ix”)

CF₃—CFHCF₂—O—CH₂CH(OCF₂CFHCF₃)—CH₂—O—CF₂CFHCF₃ (“HFE-x”)

CF₂HCF₂—O—C₂H₄—O—CF₂CF₂H (“HFE-xi”)

Lithium bis(pentafluoroethanesulfonyl)imide (FLUORAD FC-130 or FLUORAD 13858 by Sumitomo 3M Co., Ltd.) (“LiBETI”)

Lithium hexafluorophosphate (LiPF₆)

Lithium bis(trifluoromethanesulfonyl)imide (FLUORAD HQ-115 by 3M Co. or HQ-115J by Sumitomo 3M Co., Ltd.) (“LiTFSI”)

Bis(nonafluorobutanesulfonyl)imide (“LiDBI”)

Lithium tris(trifluoromethanesulfonyl)methide (“LiTFM”)

Ethylene sulfite (“ES”)

Propanesultone (“PS”)

Cyclohexylbenzene (“CHB”)

Table 1 shows the boiling points and halogenation ratios of each of the solvent components used in the experiments.

TABLE 1
Boiling points and halogenation ratios of solvents

| Solvent | EC | PC | DEC | EMC | DME | THF | THP |
|---|---|---|---|---|---|---|---|
| Boiling point/° C. | 238 | 242 | 127 | 108 | 84 | 66 | 88 |
| Halogenation ratio/% | 0 | 0 | 0 | 0 | 0 | 0 | 0 |
| Solvent | HFE-i | HFE-ii | HFE-iii | HFE-iv | HFE-v | HFE-vi | HFE-vii |
| Boiling point/° C. | 98 | 164 | 180 | 166 | 168 | 198 | 210 |
| Halogenation ratio/% | 81.3 | 66.7 | 60.0 | 66.7 | 66.7 | 72.7 | 76.9 |

| Solvent | HFE-viii | HFE-ix | HFE-x | HFE-xi |
|---|---|---|---|---|
| Boiling point/° C. | 200 | 170 | 215 | 147 |
| Halogenation ratio/% | 57.1 | 60.0 | 69.2 | 57.1 |

The concentration unit according to the following definition was used for the supporting electrolyte concentration.

molal/L: The moles of supporting electrolyte dissolved per liter of solvent components

### Experiment A (Nonaqueous Electrolyte Solution Stability)

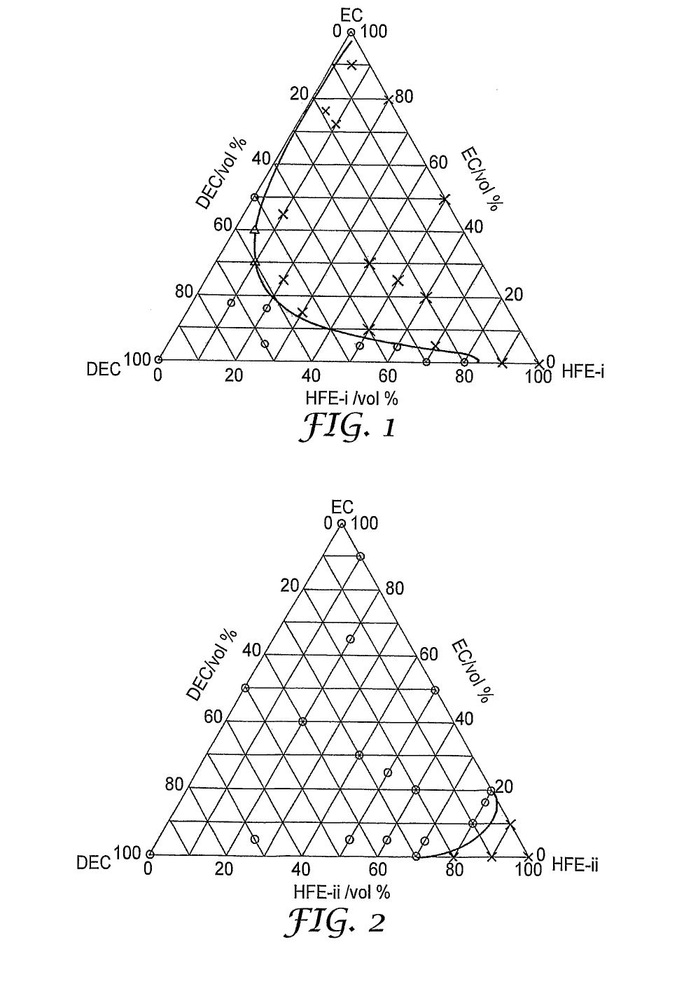

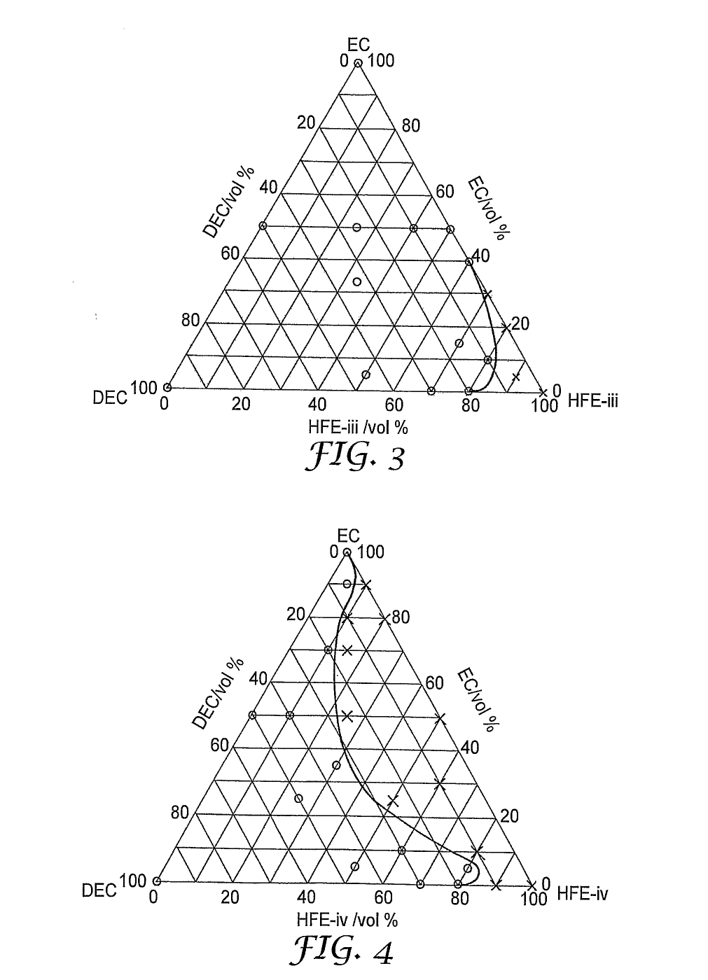

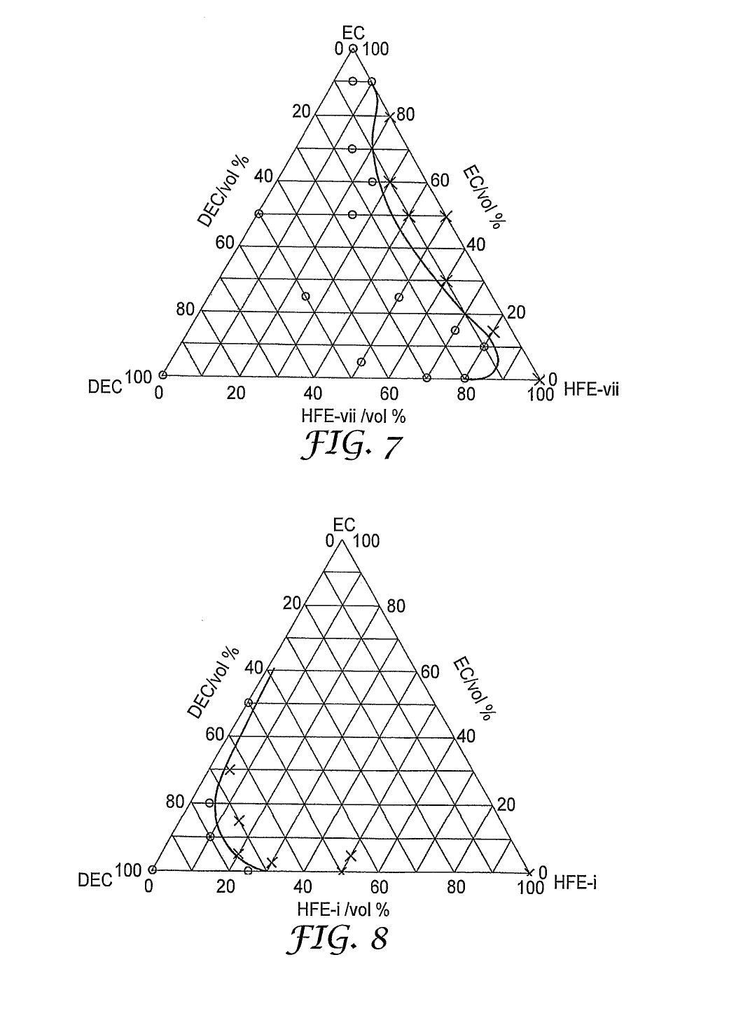

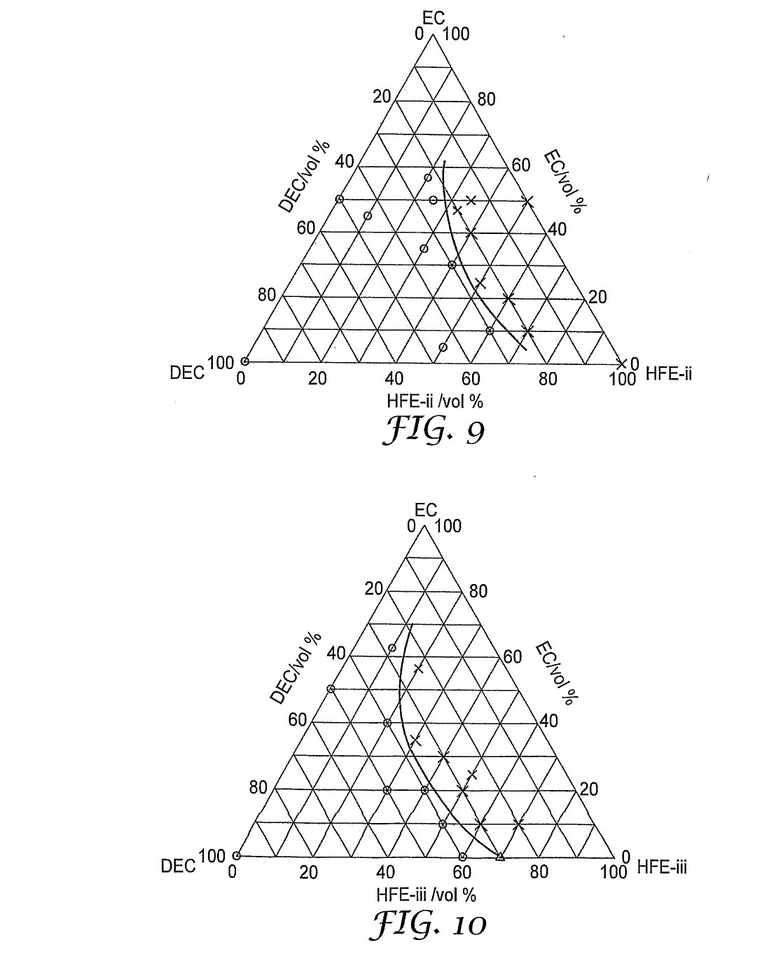

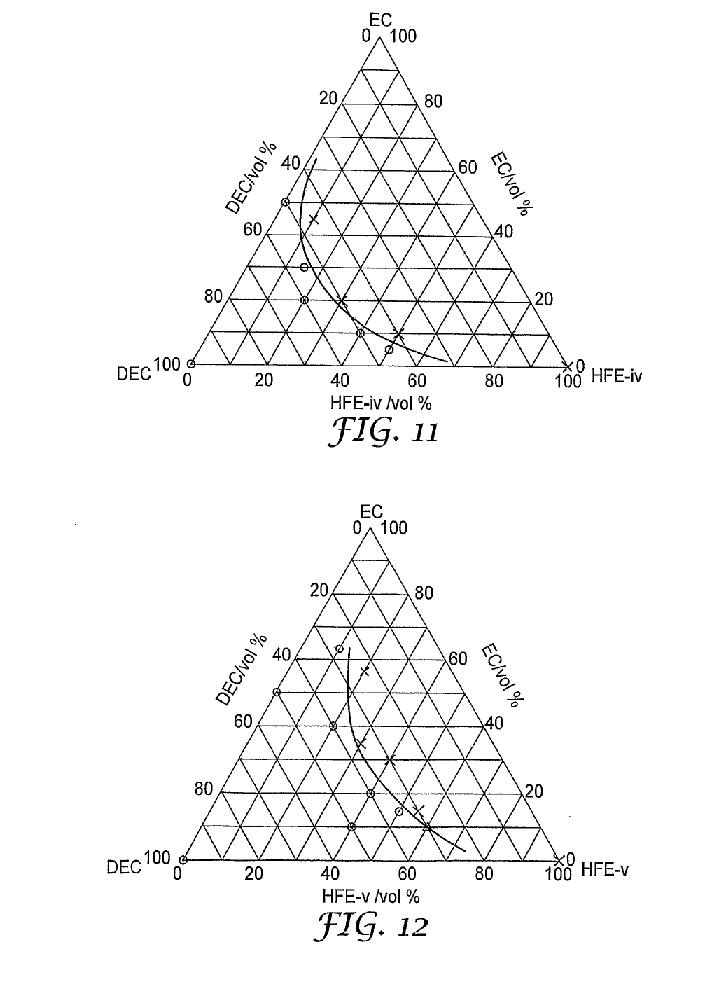

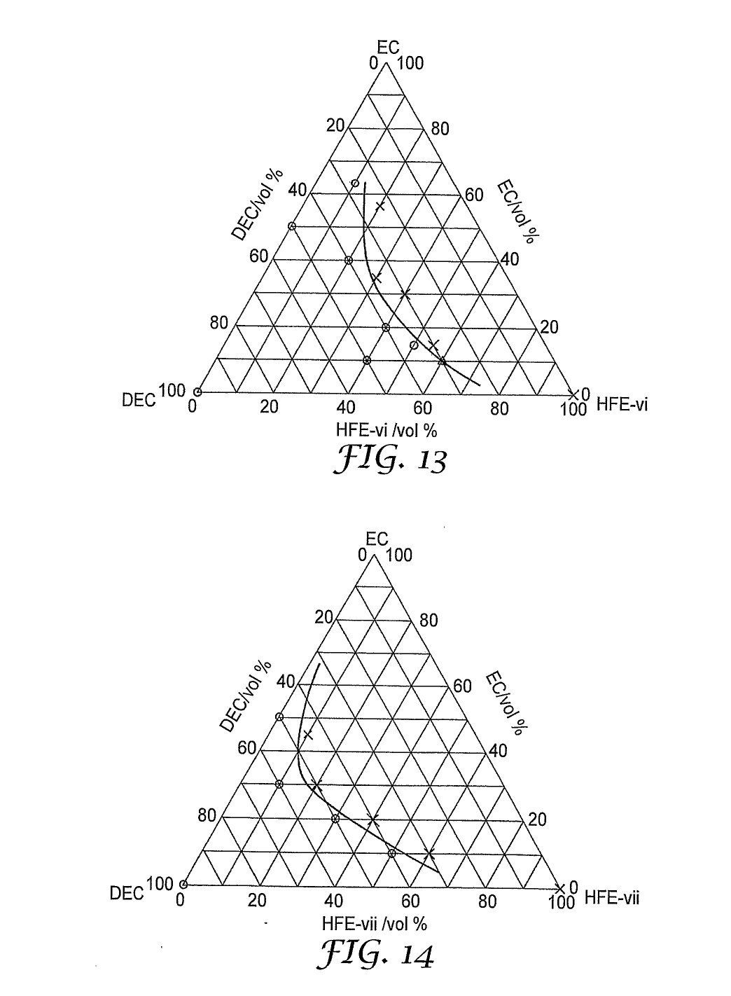

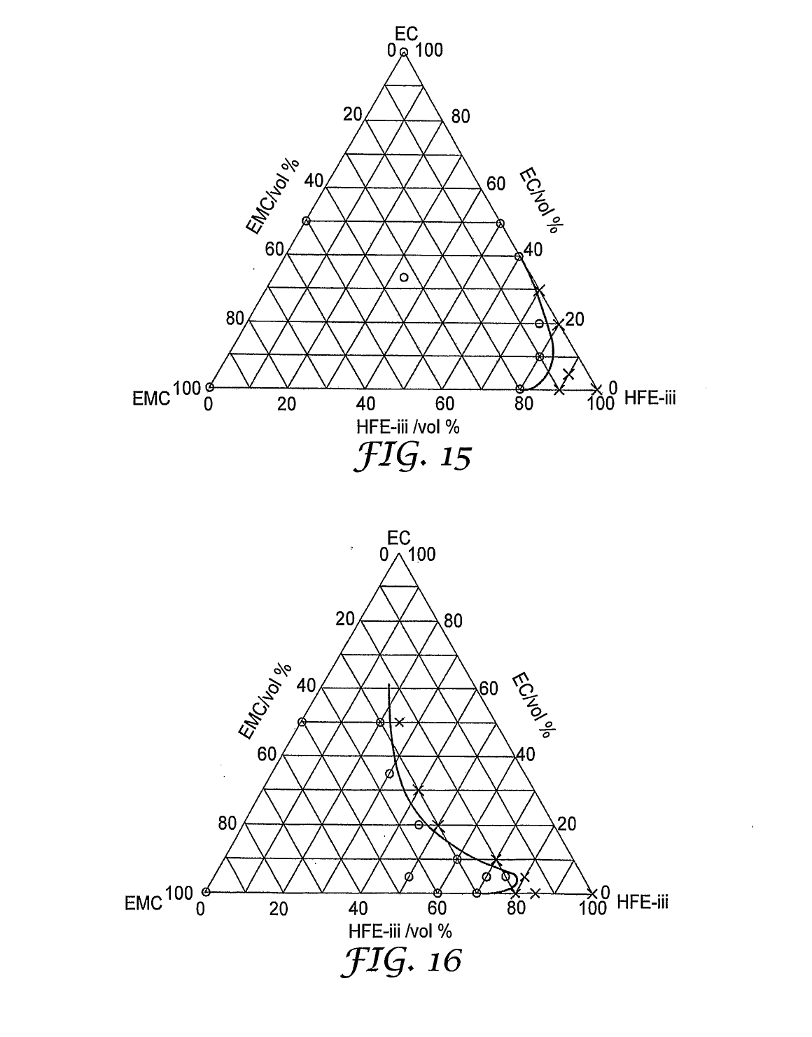

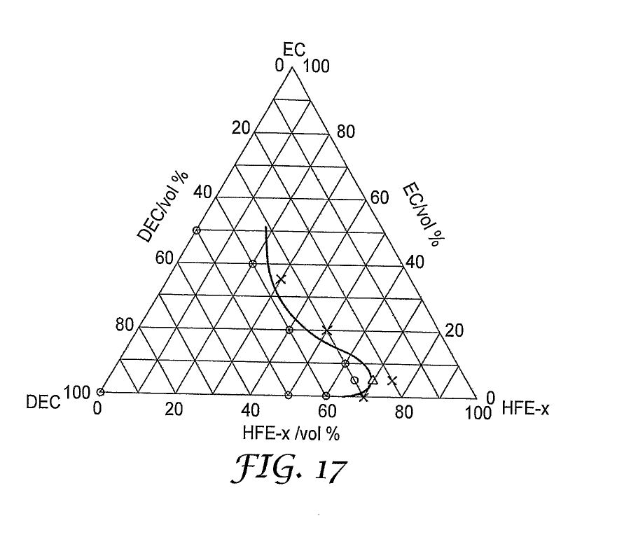

In a three-component mixed nonaqueous solvent comprising EC as the cyclic carbonic acid ester solvent, DEC or EMC as the aprotic solvent other than the cyclic carbonic acid ester and a fluorine-containing solvent there was dissolved a lithium salt as the supporting electrolyte to 1 molal/L at 25° C., to adjust the nonaqueous electrolyte, and the stabilities of different nonaqueous electrolytes were examined with different proportions of the three solvent components. The combinations of the fluorine-containing solvents and lithium salts used are shown in Table Al, and the results are shown in FIGS. 1-17.

TABLE A1
Combinations of nonaqueous electrolyte components

| | Cyclic | Aprotic solvent | | |
|---|---|---|---|---|
| | carbonic | other than | Fluorine- | |
| | acid ester | cyclic carbonic | containing | Supporting |
| Test No. | solvent | acid ester | solvent | electrolyte |
| Example A1 | EC | DEC | HFE-i | LiBETI |
| Example A2 | EC | DEC | HFE-ii | LiBETI |
| Example A3 | EC | DEC | HFE-iii | LiBETI |
| Example A4 | EC | DEC | HFE-iv | LiBETI |
| Example A5 | EC | DEC | HFE-v | LiBETI |
| Example A6 | EC | DEC | HFE-vi | LiBETI |
| Example A7 | EC | DEC | HFE-vii | LiBETI |
| Example A8 | EC | DEC | HFE-i | LiPF₆ |
| Example A9 | EC | DEC | HFE-ii | LiPF₆ |
| Example A10 | EC | DEC | HFE-iii | LiPF₆ |
| Example A11 | EC | DEC | HFE-iv | LiPF₆ |
| Example A12 | EC | DEC | HFE-v | LiPF₆ |
| Example A13 | EC | DEC | HFE-vi | LiPF₆ |
| Example A14 | EC | DEC | HFE-vii | LiPF₆ |
| Example A15 | EC | EMC | HFE-iii | LiBETI |
| Example A16 | EC | EMC | HFE-iii | LiPF₆ |
| Example A17 | EC | DEC | HFE-x | LiPF₆ |

The nonaqueous electrolyte solutions were uniform, transparent monophasic solutions in the region to the left of the curve for each example (in the direction of 100 vol % DEC and 0 vol % fluorine-containing solvent among the vertices of the triangle) as shown FIGS. 1 to 17. The nonaqueous electrolyte solutions were turbid with separation or with undissolved lithium salt to the right of the curve (in the direction of 100 vol % fluorine-containing solvent and 0 vol % EC among the vertices of the triangle).

Upon comparing FIGS. 1 to 17, it is seen that given the same solvent composition, an advantageously wider range of stable nonaqueous electrolyte formation exists with dissolution of the organic lithium salt LiBETI, as opposed to the inorganic lithium salt LiPF₆. In particular, the fluorine-containing solvents of Examples A2, A3 and A5 permitted preparation of the nonaqueous electrolyte as a mixed solvent only with the cyclic carbonic acid ester EC.

On the other hand, when the cases which used the inorganic lithium salt LiPF₆ are considered, combination of the aprotic solvent DEC in addition to the fluorine-containing solvent and the cyclic carbonic acid ester EC produced a sufficiently wide stable range for practical use. It should be noted here that when the supporting electrolyte was 0.1 mol/L of an inorganic lithium salt and the fluorine-containing solvent had the structure R₁—O—R_{f1} (where R₁ represents an optionally branched C1-4 alkyl group and R_{f1} represents an optionally branched C5-10 fluorinated alkyl group), the stabilization region was widened by including at least one hydrogen atom in R_{f1} (example including no hydrogen atoms in R_{f1}: Example A8; examples including a hydrogen atom in R_{f1} Examples A12, 13). When Example A10 and Example A16 are compared, it is seen that changing the aprotic solvent from DEC to EMC widened the region of compatibility for the nonaqueous electrolyte solution.

### Experiment B (Lithium Deposition/Dissolution Cycle Efficiency)

Using a nickel foil punched out into a circle as the working electrode (5 μm thickness, 16.16 mm diameter, 2.05 cm² area on each side) and metal lithium punched out into a circle (0.3 mm thickness, 16.16 mm diameter, 2.05 cm² area on each side) as the counter electrode, the electrodes were situated opposite each other across a polypropylene porous separator punched out into a circle (19 mm diameter, 25 μm thickness), to fabricate a coin-type two-electrode cell. The nonaqueous electrolytes used were those shown in Table B. First, lithium was deposited on a nickel plate for 1 hour or 3 hours at a current density of 0.2 mA/cm² based on the electrode area, followed by a 10 minute rest period. Next, the lithium on the nickel plate was dissolved up to a cell voltage of 1.5 V at a current density of 0.2 mA/cm², followed by a 10 minute rest period. This lithium deposition/dissolution process was defined as one cycle, and either 15 or 30 cycles were repeated. All of the lithium deposition/dissolution cycles were carried out at 25° C. The weight of the counter electrode lithium used in this experiment was 30 mg or greater (110 mAh or greater in terms of capacity), which was an adequately ample lithium amount under the deposition/dissolution conditions for the experiment. The nonaqueous electrolyte contents and test results are shown in Tables B1, B2, B3 and B4. The cycle efficiency was determined for each cycle according to the following formula.

(Metal lithium electrode cycle efficiency (%))=[(electrical quantity required for lithium dissolution (mAh))/(electrical quantity required for lithium deposition (mAh))]×100)

TABLE B1
Lithium deposition/dissolution cycle efficiency

| | Solvent composition | | | | | |
|---|---|---|---|---|---|---|
| | | Aprotic | | | | Average |
| | Cyclic | solvent other | | | | cycle |
| | carbonic | than cyclic | Fluorine- | | | efficiency |
| | acid ester | carbonic acid | containing | Supporting | Initial cycle | from 2nd |
| | solvent | ester | solvent | electrolyte | efficiency | cycle-15th |
| Test No. | (vol %) | (vol %) | (vol %) | (molal/L) | (%) | cycle (%) |
| Example B1-1 | EC(50) | | HFE-ii(50) | LiBETI(1) | 87.9 | 95.2 |
| Example B1-2 | EC(50) | | HFE-ii(50) | LiBETI(1) | 89.1 | 94.7 |
| Example B1-3 | EC(50) | THF(25) | HFE-ii(25) | LiBETI(1) | 85.8 | 93.4 |
| Example B1-4 | EC(50) | THP(25) | HFE-ii(25) | LiBETI(1) | 85.1 | 93.7 |
| Comp. Ex. B1-1 | EC(50) | DEC(50) | | LiBETI(1) | 81.2 | 88.7 |
| Comp. Ex. B1-2 | EC(50) | THF(50) | | LiBETI(1) | 81.9 | 91.7 |
| Comp. Ex. B1-3 | EC(50) | THP(50) | | LiBETI(1) | 76.1 | 91.9 |
| Comp. Ex. B1-4 | EC(50) | DME(50) | | LiBETI(1) | 84.9 | 91.7 |
| Comp. Ex. B1-5 | | DEC(50) | HFE-ii(50) | LiBETI(1) | no cycle | no cycle |

(1 hr of lithium deposition)

TABLE B2
Lithium deposition/dissolution cycle efficiency

| | Solvent composition | | | | | |
|---|---|---|---|---|---|---|
| | | Aprotic | | | | Average |
| | Cyclic | solvent other | | | | cycle |
| | carbonic | than cyclic | Fluorine- | | | efficiency |
| | acid ester | carbonic | containing | Supporting | Initial cycle | from 2nd |
| | solvent | acid ester | solvent | electrolyte | efficiency | cycle-15th |
| Test No. | (vol %) | (vol %) | (vol %) | (molal/L) | (%) | cycle (%) |
| Example B2-1 | EC(33.3) | DEC(33.3) | HFE-ii | LiBETI(1) | 88.9 | 93.0 |
| | | | (33.3) | | | |
| Example B2-2 | EC(33.3) | DEC(33.3) | HFE-iii | LiBETI(1) | 90.3 | 93.6 |
| | | | (33.3) | | | |
| Example B2-3 | EC(33.3) | DEC(33.3) | HFE-iv | LiBETI(1) | 89.6 | 93.1 |
| | | | (33.3) | | | |
| Example B2-4 | EC(33.3) | DEC(33.3) | HFE-vii | LiBETI(1) | 89.6 | 92.2 |
| | | | (33.3) | | | |
| Comp. Ex. B2-1 | EC(33.3) | DEC(66.6) | | LiBETI(1) | 86.9 | 89.3 |

(1 hr of lithium deposition)

TABLE B3
Lithium deposition/dissolution cycle efficiency

| | Solvent composition | | | | | |
|---|---|---|---|---|---|---|
| | | Aprotic | | | | Average |
| | Cyclic | solvent other | | | | cycle |
| | carbonic | than cyclic | Fluorine- | | | efficiency |
| | acid ester | carbonic | containing | Supporting | Initial cycle | from 2nd |
| | solvent | acid ester | solvent | electrolyte | efficiency | cycle-15th |
| Test No. | (vol %) | (vol %) | (vol %) | (molal/L) | (%) | cycle (%) |
| Example B3-1 | EC(30) | DEC(40) | HFE-ii(30) | LiPF₆(1) | 76.7 | 82.9 |
| Comp. Ex. B3-1 | EC(30) | DEC(70) | | LiPF₆(1) | 73.6 | 66.8 |
| Example B3-2 | EC(30) | DEC(30) | HFE-ii(40) | LiTFSI(1) | 92.0 | 93.1 |
| Comp. Ex. B3-2 | EC(30) | DEC(70) | | LiTESI(1) | 80.7 | 77.6 |
| Example B3-3 | EC(30) | DEC(30) | HFE-ii(40) | LiBETI(1) | 92.3 | 93.4 |
| Comp. Ex. B3-3 | EC(30) | DEC(70) | | LiBETI(1) | 82.2 | 77.8 |
| Example B3-4 | EC(30) | DEC(30) | HFE-ii(40) | LiDBI(1) | 91.1 | 93.2 |
| Comp. Ex. B3-4 | EC(30) | DEC(70) | | LiDBI(1) | 78.2 | 78.3 |
| Example B3-5 | EC(30) | DEC(30) | HFE-ii(40) | LiTFM(1) | 92.8 | 94.6 |
| Comp. Ex. B3-5 | EC(30) | DEC(70) | | LiTFM(1) | 81.8 | 79.8 |

(3 hrs of lithium deposition)

TABLE B4
Lithium deposition/dissolution cycle efficiency

| | Solvent composition | | | | | | |
|---|---|---|---|---|---|---|---|
| | | Aprotic | | | | | |
| | | solvent | | | | | Average |
| | Cyclic | other than | | | | | cycle |
| | carbonic | cyclic | Fluorine- | | | Initial | efficiency |
| | acid ester | carbonic | containing | Supporting | | cycle | from 2nd |
| | solvent | acid ester | solvent | electrolyte | Additive | efficiency | cycle-30th |
| Test No. | (vol %) | (vol %) | (vol %) | (molal/L) | (wt %) | (%) | cycle (%) |
| Example B4-1 | PC(50) | | HFE-ii(50) | LiBETI(1) | | 82.4 | 82.6 |
| Comp. Ex. B4-1 | PC(50) | DME(50) | | LiBETI(1) | | 82.3 | 67.7 |
| Example B4-2 | EC(35) | EMC(35) | HFE-ii(30) | LiBETI(1) | | 82.4 | 92.1 |
| Example B4-3 | EC(35) | EMC(35) | HFE-ii(30) | LiBETI(1) | ES(3) | 77.8 | 92.9 |
| Example B4-4 | EC(35) | EMC(35) | HFE-ii(30) | LiBETI(1) | PS(3) | 82.4 | 93.2 |
| Example B4-5 | EC(35) | EMC(35) | HFE-ii(30) | LiBETI(1) | CHB(3) | 86.6 | 90.2 |
| Comp. Ex. B4-2 | EC(35) | EMC(65) | | LiBETI(1) | | 81.1 | 87.3 |

(1 hr of lithium deposition)

Table B1 shows the results wherein the cyclic carbonic acid ester EC was fixed at 50 vol %, and the remaining solvent components were fluorine-containing solvents and/or different aprotic solvents. In all of the examples with fluorine-containing solvents, initial cycle efficiency and the efficiency from the 2nd cycle onward were improved compared to Comparative Examples B1-1 to B1-4 which were cases which contained only an aprotic solvent in addition to EC. In Comparative Example B1-5 which did not use EC, no lithium deposition/dissolution cycle occurred.

Table B2 shows the results wherein the proportion (of EC as cyclic carbonic acid ester/DEC as aprotic solvent/fluorine-containing solvent) was fixed at 1/1/1, and only the type of fluorine-containing solvent was changed. Comparative Example B2-1 used DEC instead of a fluorine-containing solvent in the same composition (i.e., EC/DEC=½), and in comparison to this, the initial cycle efficiency and efficiency from the 2nd cycle onward were improved in all of the examples.

The examples in Table B3 had the cyclic carbonic acid ester EC fixed at 30 vol %, with the remainder of the solvent composition consisting of DEC as the aprotic solvent and HFE-ii as the fluorine-containing solvent, while changing the type of supporting electrolyte. When the examples and comparative examples employing the same supporting electrolyte are compared, all of the examples exhibited improved initial cycle efficiency and efficiency from the 2nd cycle onward compared to the comparative examples having the fluorine-containing solvent replaced with DEC.

Example B4-1 and Comparative Example B4-1 in Table B4 employed PC as the cyclic carbonic acid ester. The initial cycle efficiencies were roughly equivalent, but from the 2nd cycle onward the efficiency was higher for the example which included a fluorine-containing solvent.

Examples B4-2 to B4-5 and Comparative Example B4-2 employed EMC as the aprotic solvent, and contained additives in some cases. The efficiency from the 2nd cycle onward was greater in all of the examples which contained a fluorine-containing solvent, compared to the comparative example. Although the initial cycle efficiency with addition of ES in Example B4-3 was lower than the comparative example, this is believed to have occurred because of the extra electrical quantity consumed for the self-sacrificial electrical decomposition of ES, in addition to the electrical quantity required for lithium deposition during the initial lithium deposition.

### Experiment C (Graphite Electrode Cycle Efficiency)

A slurry liquid was prepared comprising mesophase carbon microbeads as the active substance, conductive carbon as a conductive adjuvant, polyvinylidene fluoride as a binder and N-methyl-2-pyrrolidone as the solvent. The composition of the slurry liquid was adjusted so that the dried electrode composition comprised 81% active substance, 9% conductive adjuvant and 10% binder, and after coating onto a 25 μm-thick copper foil, it was dried. This was then punched into a circle (16.16 mm diameter, 2.05 cm² area on each side) to fabricate a working electrode. Based on the weight of the fabricated working electrode, the composition of the dried electrode and the ideal theoretical capacity of 372 mAh/g for the active substance, the fabricated working electrode was considered to have a capacity of about 1.0-1.1 mAh. The counter electrode was metal lithium punched into a circle (0.3 mm thickness, 16.16 mm diameter, 2.05 cm² area on each side), and the working electrode and counter electrode were situated opposite each other across a polypropylene porous separator punched out into a circle (19 mm diameter, 25 μm thickness), to fabricate a coin-type two-electrode cell. The nonaqueous electrolytes used were those shown in Table C. First, lithium ion was intercalated into the active substance at a constant current of 0.2 CmA, CmAh being the capacity of the working electrode determined by calculation, to a cell voltage of 0 V, followed by a 10 minute rest period. Next, the lithium ion was deintercalated from the active substance up to a cell voltage of 1.5 V at a constant current of 0.2 CmA, followed by a 10 minute rest period. This lithium intercalation/deintercalation process was defined as one cycle, and 10 cycles were repeated. All of the lithium intercalation/deintercalation cycles were carried out at 25° C. The weight of the counter electrode lithium used in this experiment was 30 mg or greater (110 mAh or greater in terms of capacity), which was an adequately ample lithium amount compared to the capacity of the working electrode used for the experiment. The nonaqueous electrolyte contents and test results are shown in Tables C1, C2 and C3. The cycle efficiency was determined for each cycle according to the following formula.

(Graphite electrode cycle efficiency (%))=[(electrical quantity required for lithium ion deintercalation (mAh))/(electrical quantity required for lithium ion intercalation (mAh))]×100

TABLE C1
Graphite electrode cycle efficiency

| | Solvent composition | | | | | |
|---|---|---|---|---|---|---|
| | | Aprotic | | | | |
| | | solvent | | | | Average |
| | Cyclic | other than | | | | cycle |
| | carbonic | cyclic | Fluorine- | | | efficiency |
| | acid ester | carbonic | containing | Supporting | Initial cycle | from 2nd |
| | solvent | acid ester | solvent | electrolyte | efficiency | cycle-10th |
| Test No. | (vol %) | (vol %) | (vol %) | (molal/L) | (%) | cycle (%) |
| Example C1-1 | EC(50) | | HFE-ii(50) | LiBETI(1) | 91.3 | >99.9 |
| Example C1-2 | EC(50) | | HFE-iii(50) | LiBETI(1) | 91.4 | 99.7 |
| Comp. Ex. C1-1 | EC(50) | DEC(50) | | LiBETI(1) | 81.4 | 99.8 |
| Comp. Ex. C1-2 | EC(50) | THF(50) | | LiBETI(1) | 69.5 | 99.0 |
| Comp. Ex. C1-3 | EC(50) | THP(50) | | LiBETI(1) | 62.3 | 99.2 |
| Comp. Ex. C1-4 | EC(50) | DME(50) | | LiBETI(1) | 63.4 | 98.5 |

TABLE C2
Graphite electrode cycle efficiency

| | Solvent composition | | | | | |
|---|---|---|---|---|---|---|
| | | Aprotic | | | | Average |
| | Cyclic | solvent other | | | | cycle |
| | carbonic | than cyclic | Fluorine- | | | efficiency |
| | acid ester | carbonic | containing | Supporting | Initial cycle | from 2nd |
| | solvent | acid ester | solvent | electrolyte | efficiency | cycle-15th |
| Test No. | (vol %) | (vol %) | (vol %) | (molal/L) | (%) | cycle (%) |
| Example C2-1 | EC(33.3) | DEC(33.3) | HFE-ii | LiBETI(1) | 91.3 | >99.9 |
| | | | (33.3) | | | |
| Example C2-2 | EC(33.3) | DEC(33.3) | HFE-iii | LiBETI(1) | 90.4 | 99.7 |
| | | | (33.3) | | | |
| Example C2-3 | EC(33.3) | DEC(33.3) | HFE-iv | LiBETI(1) | 91.1 | 99.7 |
| | | | (33.3) | | | |
| Example C2-4 | EC(33.3) | DEC(33.3) | HFE-v | LiBETI(1) | 90.1 | 99.8 |
| | | | (33.3) | | | |
| Example C2-5 | EC(33.3) | DEC(33.3) | HFE-vi | LiBETI(1) | 89.5 | 99.8 |
| | | | (33.3) | | | |
| Example C2-6 | EC(33.3) | DEC(33.3) | HFE-vii | LiBETI(1) | 90.5 | >99.9 |
| | | | (33.3) | | | |
| Comp. Ex. C2-1 | EC(33.3) | DEC(66.6) | | LiBETI(1) | 74.4 | 99.0 |

TABLE C3
Graphite electrode cycle efficiency

| | Solvent composition | | | | | |
|---|---|---|---|---|---|---|
| | | Aprotic | | | | Average |
| | Cyclic | solvent other | | | | cycle |
| | carbonic | than cyclic | Fluorine- | | | efficiency |
| | acid ester | carbonic acid | containing | Supporting | Initial cycle | from 2nd |
| | solvent | ester | solvent | electrolyte | efficiency | cycle-10th |
| Test No. | (vol %) | (vol %) | (vol %) | (molal/L) | (%) | cycle (%) |
| Example C3-1 | EC(5) | DEC(45) | HFE-i(50) | LiBETI(1) | 90.6 | 99.7 |
| Comp. Ex. C3-1 | EC(5) | DEC(95) | | LiBETI(1) | 87.0 | 97.8 |

Table C1 shows the results wherein the cyclic carbonic acid ester EC was fixed at 50 vol %, and the remaining solvent components were fluorine-containing solvents or different aprotic solvents. In all of the examples with fluorine-containing solvents, initial cycle efficiency was vastly improved compared to the comparative examples which contained only an aprotic solvent in addition to EC. This means that when a carbon material capable of intercalation/deintercalation of lithium ion is used as the electrode active substance, using a nonaqueous electrolyte comprising a fluorine-containing solvent makes it possible to greatly reduce the irreversible capacity of the electrode.

Table C2 shows the results wherein the proportion (of EC as cyclic carbonic acid ester/DEC as aprotic solvent/fluorine-containing solvent) was fixed at 1/1/1, and only the type of fluorine-containing solvent was changed. Comparative Example C2-1 used DEC instead of a fluorine-containing solvent in the same composition (i.e., EC/DEC=½), and in comparison to this, the initial cycle efficiency was vastly improved in all of the examples. This means that when a carbon material capable of intercalation/deintercalation of lithium ion is used as the electrode active substance, using a nonaqueous electrolyte comprising a fluorine-containing solvent makes it possible to greatly reduce the irreversible capacity of the electrode. The efficiency from the 2nd cycle onward was also improved to a level near 100%.

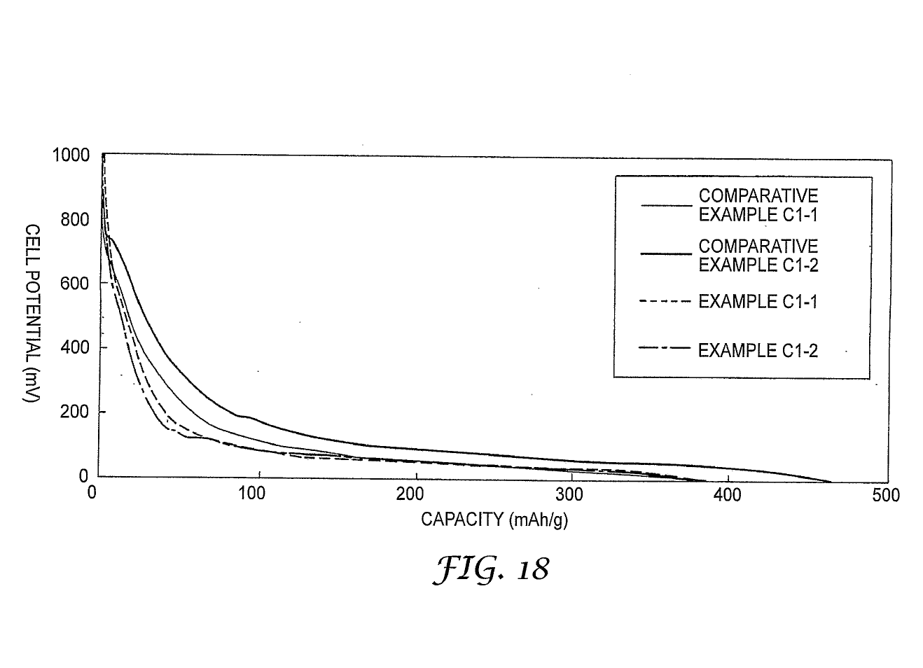

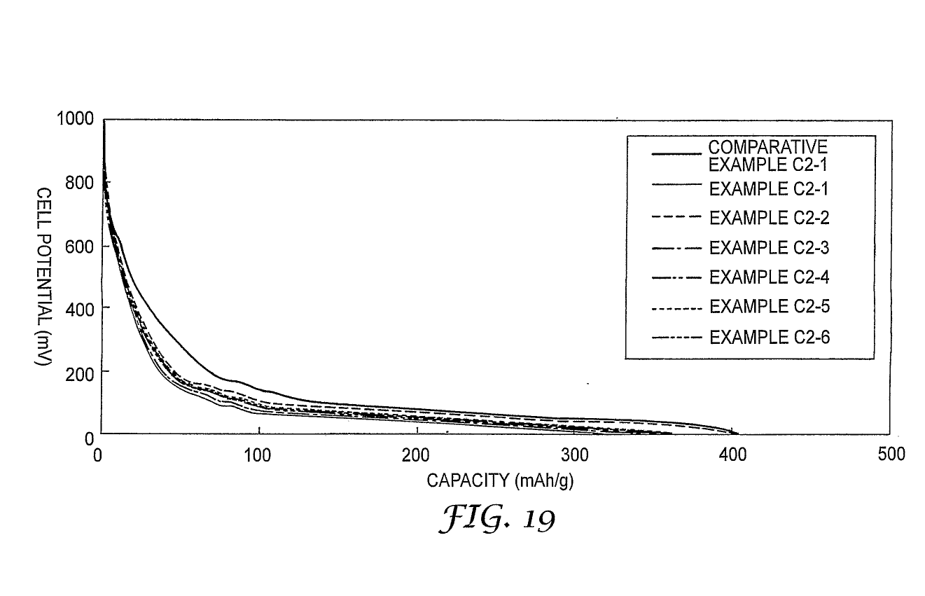

FIGS. 18 and 19 show cell potential profiles during initial lithium ion intercalation, for some of the experiments in Table C1 and the experiments in Table C2. In these examples, the cell potential decreases rapidly compared to the comparative examples, up to about 0.2 V at which intercalation of lithium ion actually occurs, and the electric quantity consumed for electrochemical decomposition of the solvent and formation of the coating on the electrode surface is smaller. Since the cells of the examples also allowed repeat of the cycle at high efficiency thereafter, they were considered ideal and had adequate strength even though the surface coating formed during the initial lithium ion intercalation was thin and/or patchy.

Table C3 shows examples having small amounts of EC, as the component necessary for charge/discharge of the graphite electrode. The initial cycle efficiency and cycle efficiency from the 2nd cycle onward were improved in Example C3-1 which comprised a fluorine-containing solvent, compared to the comparative example which contained only an aprotic solvent in addition to EC.

### Experiment D (Lithium-Cobalt Composite Oxide Electrode Cycle Efficiency and Cycle Characteristic)

A slurry liquid was prepared comprising lithium cobalt (LiCoO₂) as the active substance, acetylene black as a conductive adjuvant, polyvinylidene fluoride as a binder and N-methyl-2-pyrrolidone as the solvent. The composition of the slurry liquid was adjusted so that the dried electrode composition comprised 90% active substance, 5% conductive adjuvant and 5% binder, and after coating onto a 25 μm-thick aluminum foil, it was dried. This was then punched into a circle (15.96 mm diameter, 2.00 cm² area on each side) to fabricate a working electrode. Based on the weight of the fabricated working electrode, the composition of the dried electrode and the ideal theoretical capacity of 137 mAh/g for the active substance, the fabricated working electrode was considered to have a capacity of about 0.7 mAh. The counter electrode was metal lithium punched into a circle (0.3 mm thickness, 16.16 mm diameter, 2.05 cm² area on each side), and the working electrode and counter electrode were situated opposite each other across a polypropylene porous separator punched out into a circle (19 mm diameter, 25 μm thickness), to fabricate a coin-type two-electrode cell. The nonaqueous electrolytes used were those shown in Table D. First, lithium ion was deintercalated from the active substance at a constant current of 0.2 CmA, CmAh being the capacity of the working electrode determined by calculation, to a cell voltage of 4.2 V, followed by a 10 minute rest period. Next, lithium ion was intercalated into the active substance up to a cell voltage of 2.5 V at a constant current of 0.2 CmA, followed by a 10 minute rest period. This lithium deintercalation/intercalation process was defined as one cycle, and 20 cycles were repeated. All of the lithium deintercalation/intercalation cycles were carried out at 25° C. The weight of the counter electrode lithium used in this experiment was 30 mg or greater (110 mAh or greater in terms of capacity), which was an adequately ample lithium amount compared to the capacity of the working electrode used for the experiment. The nonaqueous electrolyte contents and cycle efficiency test results are shown in Table D1a. The cycle efficiency was determined for each cycle according to the following formula.

(Lithium-cobalt composite oxide electrode cycle efficiency (%))=[(electrical quantity required for lithium ion intercalation (mAh))/(electrical quantity required for lithium ion deintercalation (mAh))]×100

The cells evaluated here comprised LiCoO₂ as the working electrode and lithium as the counter electrode, which corresponds to a metal lithium secondary battery having a LiCoO₂ positive electrode and a lithium negative electrode. The process of intercalation of lithium ion into the working electrode was therefore considered to be the battery discharge process. The battery cycle characteristics are shown in Table D1b.

TABLE D1a
Lithium-cobalt composite oxide electrode cycle efficiency

| | Solvent composition | | | | | |
|---|---|---|---|---|---|---|
| | | Aprotic | | | | Average |
| | Cyclic | solvent other | | | | cycle |
| | carbonic | than cyclic | Fluorine- | | | efficiency |
| | acid ester | carbonic | containing | Supporting | Initial cycle | from |
| | solvent | acid ester | solvent | electrolyte | efficiency | 2nd cycle-20th |
| Test No. | (vol %) | (vol %) | (vol %) | (molal/L) | (%) | cycle (%) |
| Example D1-1 | EC(50) | | HFE- | LiBETI(1) | 98.2 | >99.9 |
| | | | ii(50) | | | |
| Example D1-2 | EC(50) | | HFE- | LiBETI(1) | 96.7 | >99.9 |
| | | | iii(50) | | | |
| Comp. Ex. D1-1 | EC(50) | DEC(50) | | LiBETI(1) | 97.1 | >99.9 |
| Comp. Ex. D1-2 | EC(50) | THF(50) | | LiBETI(1) | 93.9 | 99.7 |
| Comp. Ex. D1-3 | EC(50) | THP(50) | | LiBETI(1) | 95.6 | 99.7 |
| Comp. Ex. D1-4 | EC(50) | DME(50) | | LiBETI(1) | 94.9 | 99.6 |

TABLE D1b
Lithium metal secondary battery cycle characteristics

| | Discharge capacity (electrical | | | | | |
|---|---|---|---|---|---|---|
| | quantity required for lithium ion | | | | | |
| | intercalation into LiCoO₂)/mAh | | | Discharge capacity persistence/% | | |
| | (per 1 g LiCoO₂) | | | (initial discharge capacity = 100%) | | |
| Test No. | Initial | 10th cycle | 20th cycle | Initial | 10th cycle | 20th cycle |
| Example D1-1 | 141 | 137 | 128 | 100 | 97 | 91 |
| Example D1-2 | 137 | 134 | 126 | 100 | 98 | 92 |
| Comp. Ex. D1-1 | 135 | 124 | 106 | 100 | 92 | 78 |
| Comp. Ex. D1-2 | 136 | 106 | 54 | 100 | 78 | 40 |
| Comp. Ex. D1-3 | 134 | 121 | 96 | 100 | 90 | 72 |
| Comp. Ex. D1-4 | 138 | 117 | 89 | 100 | 84 | 65 |

Tables D1a and D1b show the results for two-component mixed solvent systems wherein the supporting electrolyte was LiBETI and EC was fixed at 50%. In the examples of the invention, the initial cycle efficiency and cycle efficiency from the 2nd cycle onward were improved, while the capacity persistence after cycle completion was also vastly improved.

The following tables D2a and D2b show further results from measurement using different mixed solvent systems.

TABLE D2a
Lithium-cobalt composite oxide electrode cycle efficiency

| | Solvent composition | | | | | |
|---|---|---|---|---|---|---|
| | | Aprotic | | | | Average |
| | Cyclic | solvent other | | | | cycle |
| | carbonic | than cyclic | Fluorine- | | | efficiency |
| | acid ester | carbonic | containing | Supporting | Initial cycle | from 2nd |
| | solvent | acid ester | solvent | electrolyte | efficiency | cycle-20th |
| Test No. | (vol %) | (vol %) | (vol %) | (molal/L) | (%) | cycle (%) |
| Example D2-1 | EC(5) | DEC(45) | HFE-ii | LiPF₆(1) | 98.5 | 99.8 |
| | | | (50) | | | |
| Example D2-2 | EC(5) | DEC(45) | HFE-iii | LiPF₆(1) | 99.1 | >99.9 |
| | | | (50) | | | |
| Example D2-3 | EC(5) | DEC(45) | HFE-iv | LiPF₆(1) | 98.5 | >99.9 |
| | | | (50) | | | |
| Example D2-4 | EC(5) | DEC(45) | HFE-v | LiPF₆(1) | 98.7 | >99.9 |
| | | | (50) | | | |
| Example D2-5 | EC(5) | DEC(45) | HFE-vi | LiPF₆(1) | 99.6 | >99.9 |
| | | | (50) | | | |
| Example D2-6 | EC(5) | DEC(45) | HFE-vii | LiPF₆(1) | 98.7 | 99.8 |
| | | | (50) | | | |
| Comp. Ex. D2-1 | EC(5) | DEC(95) | | LiPF₆(1) | 99.0 | 78.4* |

*Comparative Example D2-1 shows the average efficiency from the 2nd cycle to the 10 cycle, due to lack of operation from the 11th cycle onward.

TABLE D2b
Lithium metal secondary battery cycle characteristics

| | Discharge capacity (electrical | | | | | |
|---|---|---|---|---|---|---|
| | quantity required for lithium ion | | | | | |
| | intercalation into LiCoO₂)/mAh | | | Discharge capacity persistence/% | | |
| | (per 1 g LiCoO₂) | | | (initial discharge capacity = 100%) | | |
| Test No. | Initial | 10th cycle | 20th cycle | Initial | 10th cycle | 20th cycle |
| Example D2-1 | 135 | 134 | 133 | 100 | >99 | 98 |
| Example D2-2 | 140 | 139 | 137 | 100 | 99 | 98 |
| Example D2-3 | 144 | 142 | 140 | 100 | 99 | 97 |
| Example D2-4 | 140 | 138 | 135 | 100 | 99 | 97 |
| Example D2-5 | 140 | 138 | 134 | 100 | 98 | 96 |
| Example D2-6 | 137 | 137 | 135 | 100 | 100 | 98 |
| Comp. Ex. D2-1 | 122 | 30 | 0 | 100 | 25 | 0 |

Tables D2a and D2b show the results for three-component mixed solvents wherein the supporting electrolyte was LiPF₆, with fixed contents of EC at 5%, DEC at 45% and the fluorine-containing solvent at 50%. Comparative Example D2-1 included DEC instead of a fluorine-containing solvent, with EC/DEC=5/95. Although no notable difference was seen in the initial efficiency, the cycle efficiency from the 2nd cycle onward was improved in the examples. The capacity persistence after cycle completion was also vastly improved in the examples.

Tables D3a and D3b show the results for solvents having the same compositions as in Table D2a, but with LiBETI as the supporting electrolyte. In these examples as well, similar to Tables D2a and D2b, the cycle efficiency from the 2nd cycle onward was notably improved while the capacity persistence after cycle completion was also vastly improved.

TABLE D3a
Lithium-cobalt composite oxide electrode cycle efficiency

| | Solvent composition | | | | | |
|---|---|---|---|---|---|---|
| | | Aprotic | | | | Average |
| | Cyclic | solvent other | | | | cycle |
| | carbonic | than cyclic | Fluorine- | | | efficiency |
| | acid ester | carbonic | containing | Supporting | | from 2nd |
| | solvent | acid ester | solvent | electrolyte | Initial cycle | cycle-20th |
| Test No. | (vol %) | (vol %) | (vol %) | (molal/L) | efficiency | cycle |
| Example D3-1 | EC(5) | DEC(45) | HFE-i(50) | LiBETI(1) | 99.8 | >99.9 |
| Comp. Ex. D3-1 | EC(5) | DEC(95) | | LiBETI(1) | 98.9 | 78.5* |

*Comparative Example D3-1 shows the average efficiency from the 2nd cycle to the 10 cycle, due to lack of operation from the 11th cycle onward.

TABLE D3b
Lithium metal secondary battery cycle characteristics

| | Discharge capacity (electrical | | | | | |
|---|---|---|---|---|---|---|
| | quantity required for lithium ion | | | | | |
| | intercalation into LiCoO₂)/mAh | | | Discharge capacity persistence/% | | |
| | (per 1 g LiCoO₂) | | | (initial discharge capacity = 100%) | | |
| Test No. | Initial | 10th cycle | 20th cycle | Initial | 10th cycle | 20th cycle |
| Example D3-1 | 137 | 135 | 132 | 100 | 99 | 96 |
| Comp. Ex. D3-1 | 136 | 45 | 0 | 100 | 33 | 0 |

### Experiment E (Lithium Ion Secondary Battery Cycle Test)

A graphite electrode fabricated in the same manner as Experiment C was used as the negative electrode and a lithium cobaltate electrode fabricated in the same manner as Experiment D was used as the positive electrode, and these were used to sandwich a polypropylene porous separator to produce a coin-type lithium ion secondary battery. Each electrode capacity calculated from the theoretical capacity of the active substance was about 1.0 mAh for the positive electrode and about 1.4 mAh for the negative electrode. The compositions of the nonaqueous electrolytes used were as shown in Table E1.

TABLE E1

| | Solvent composition | | | |
|---|---|---|---|---|
| | | Aprotic | | |
| | Cyclic | solvent other | | |
| | carbonic | than cyclic | Fluorine- | |
| | acid ester | carbonic acid | containing | Supporting |
| | solvent | ester | solvent | electrolyte |
| Test No. | (vol %) | (vol %) | (vol %) | (molal/L) |
| Example E1-1, | EC(5) | DEC(45) | HFE-iii(50) | LiPF₆(1) |
| Example E2-1 | | | | |
| Example E1-2, | EC(5) | DEC(45) | HFE-v(50) | LiPF₆(1) |
| Example E2-2 | | | | |
| Comp. Ex. E1-1, | EC(50) | DEC(50) | | LiPF₆(1) |
| Comp. Ex. E2-1 | | | | |
| Comp. Ex. E1-2 | EC(5) | DEC(95) | | LiPF₆(1) |
| Example E3-1 | EC(50) | | HFE-iii(50) | LiBETI(1) |
| Example E3-2 | EC(5) | EMC(45) | HFE-iii(50) | LiBETI(1) |
| Comp. Example | EC(50) | EMC(50) | | LiBETI(1) |
| E3-1 | | | | |
| Example E4-1 | EC(5) | DEC(45) | HFE-ix(50) | LiPF₆(1) |
| Example E4-2 | EC(5) | DEC(45) | HFE-xi(50) | LiPF₆(1) |
| Example E4-3 | EC(5) | DEC(45) | HFE-viii(50) | LiPF₆(1) |

The battery cycle was carried out according to the following procedure (1) to (4).

(1) First, constant current charging was carried out at 25° C. at a current of 0.2 CmA, CmAh being the capacity of the positive electrode determined by calculation, to a cell voltage of 4.2 V, followed by a 10 minute rest period. Next, constant current discharging was carried out at a current of 0.2 CmA up to a cell voltage of 3.0 V, followed by a 10 minute rest period. This operation was defined as one cycle, and 10 cycles were repeated.

(2) The charge/discharge cycles from the 11th cycle to the 20th cycle were carried out at 25° C. with the current values for charge and discharge changed to 1 CmA.

(3) The charge/discharge cycles from the 21st cycle to the 40th cycle were carried out under one of the following conditions.

(3-1) A temperature of 0° C., with the other conditions as in (2).

(3-2) A temperature of 45° C., with the other conditions as in (2).

(4) The charge/discharge cycles from the 41st cycle to the 50th cycle were carried out under the same conditions as in (1).

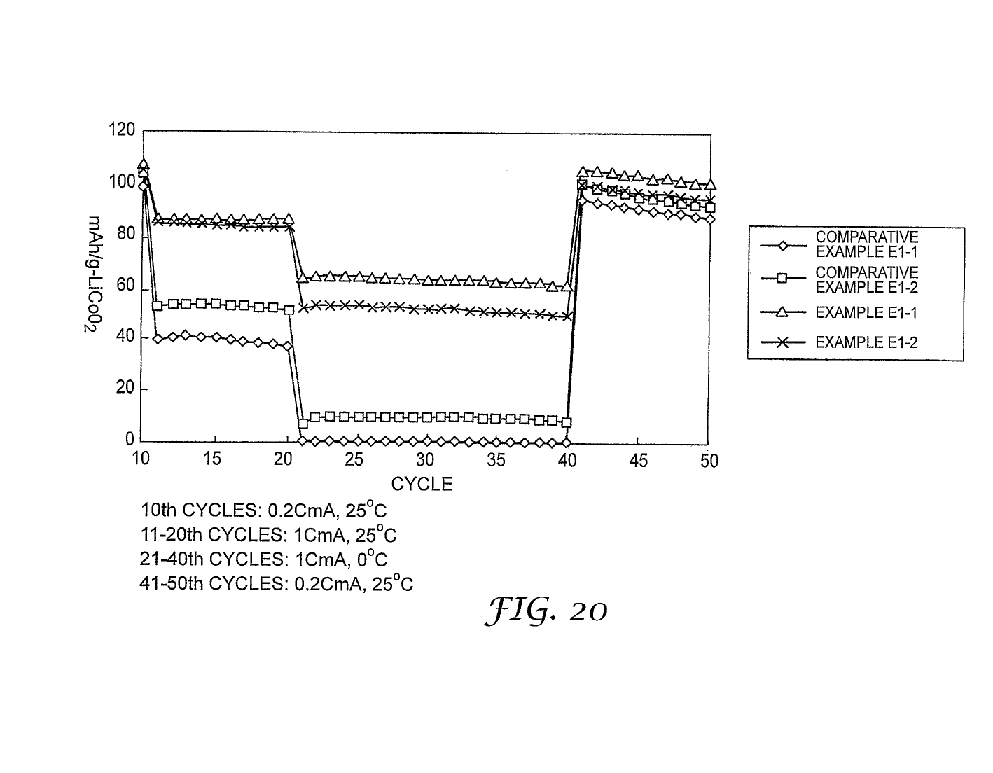

The results for the batteries at completion of step (3-1) are shown in FIG. 20.

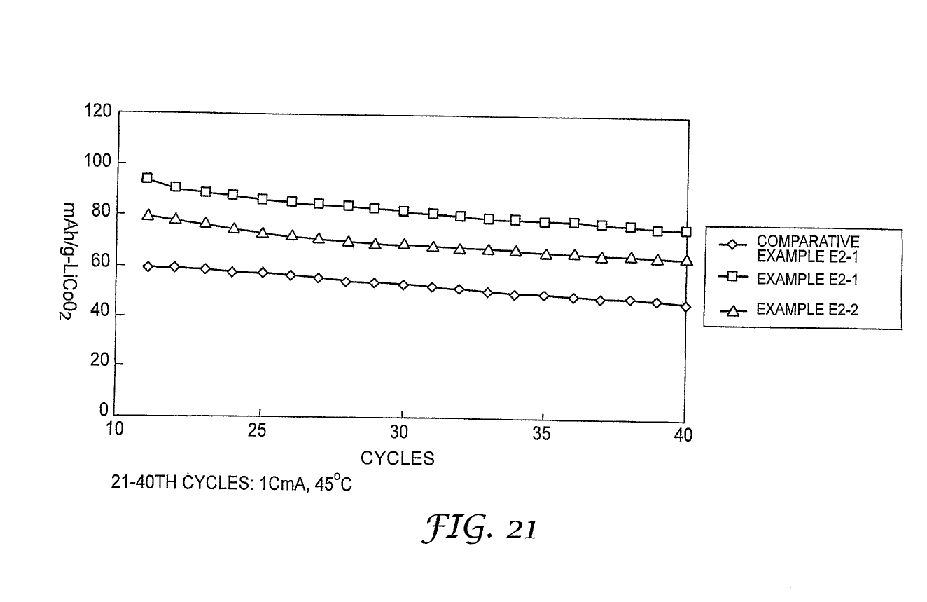

The results for the batteries at completion of step (3-2) are shown in FIG. 21.

For the experiment shown in FIG. 20, the discharge capacities of all of the batteries at the 10th cycle at 0.2 CmA, 25° C. were in the range of 99-107 mAh as calculated per gram of lithium cobalt, and normal operation was confirmed. When charge/discharge was then conducted from the 11th to 20th cycles at a relatively high rate of 1 CmA at 25° C., the discharge capacities of the examples were larger than those of the comparative examples. Also, when 1 CmA charge/discharge was conducted at a temperature of 0° C. from the 21st to the 40th cycles, a large discharge capacity was exhibited by the examples, while only very small capacity or absolute no discharge capacity was exhibited by the comparative examples. When charge/discharge was conducted at 0.2 CmA with the temperature restored to 25° C. from the 41st cycle onward, all of the batteries exhibited normal operation. These results demonstrated that a battery employing a nonaqueous electrolyte according to the invention exhibits excellent high rate charge/discharge characteristics and low-temperature charge/discharge characteristics.

For the experiment shown in FIG. 21, the discharge capacities of all of the batteries at the 10th cycle at 0.2 CmA, 25° C. were in the range of 99-109 mAh as calculated per gram of lithium cobaltate, and normal operation was confirmed. When charge/discharge was then conducted from the 11th to 20th cycles at 1 CmA, 25° C., and charge/discharge was subsequently conducted at 1 CmA with the temperature changed to 45° C. from the 21st to the 40th cycles, large discharge capacities were exhibited by the examples, as shown in FIG. 21. These results demonstrated that a battery employing a nonaqueous electrolyte according to the invention exhibits excellent high-temperature charge/discharge characteristics.

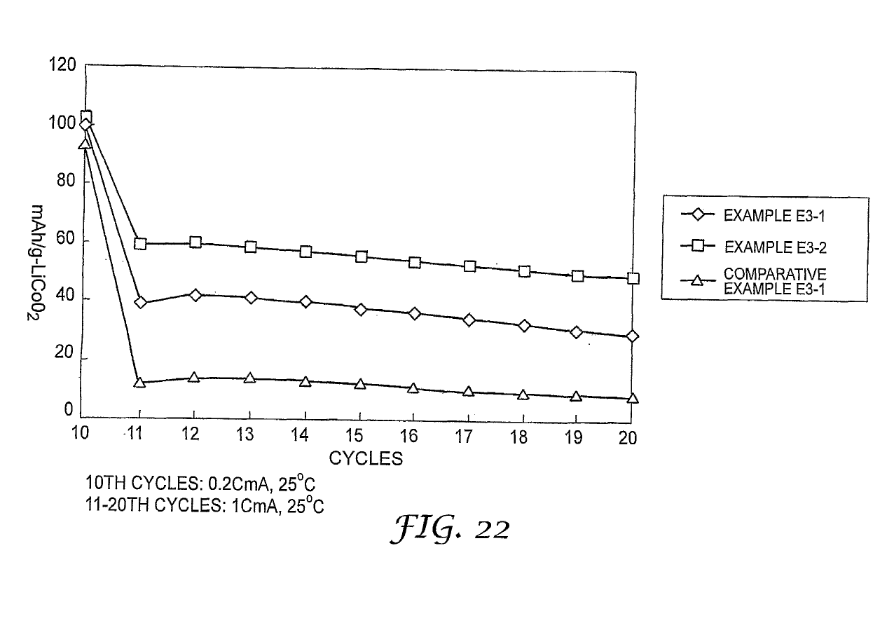

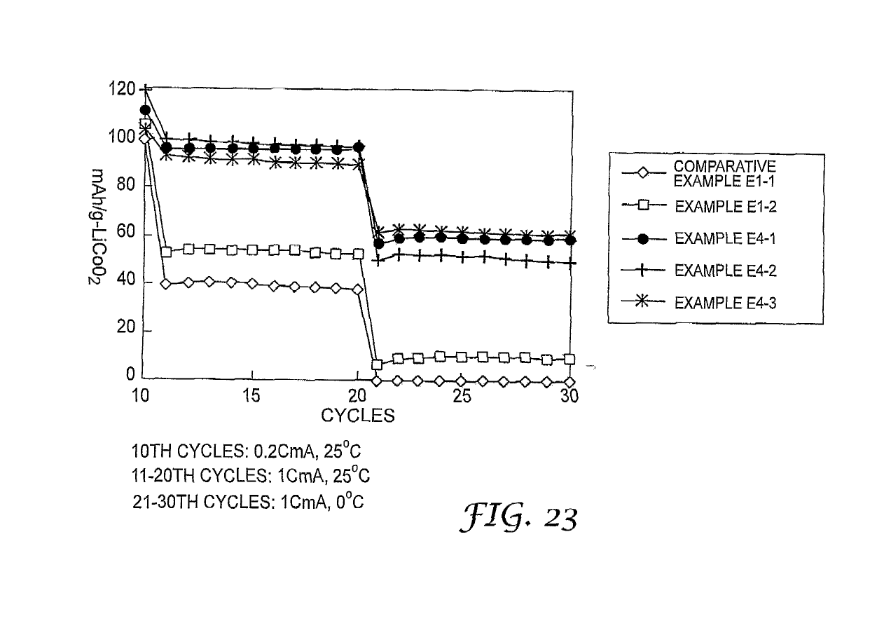

Lithium ion secondary batteries using the nonaqueous electrolyte solutions indicated as Examples E3-1, E3-2 and E3-3 in Table E1 were tested. The results shown in FIG. 22 are ones where the batteries were tested at completion of step (2). The discharge capacities of all of the batteries at the 10th cycle at 0.2 CmA, 25° C. were in the range of 99-102 mAh as calculated per gram of lithium cobaltate and their normal operations were confirmed. When charge/discharge cycles were conducted from the 11th to 20th cycles at relatively high rate of 1 CmA, the discharge capacity of the examples were larger that of the comparative example. Further, when Example E3-1 is compared with Example E3-2, the discharge capacity of Example E3-2 was shown to be higher than that of Example E3-1, Example E3-2 is one where the major portion of the cyclic carbonic acid ester, EC was replaced with the aprotic solvent other than a cyclic carbonic acid ester, EMC while the amount of the fluorine-containing solvent is constant in Example E3-1.

With respect to Examples E4-1 to E4-3 in Table E1, the results for the tests effected up to 10th cycle of step (3-1), i.e., up to the total cycles of 30 cycles, are shown in FIG. 23. As comparative examples, Comparative Examples E1-1 and E1-2 effected under the same conditions are shown. The discharge capacities of all of the batteries at the 10th cycle at 0.2 CmA, 25° C. were in the range of 99-118 mAh as calculated per gram of lithium cobaltate and their normal operations were confirmed. Next, when charge/discharge cycles were conducted from the 11th to 20th cycles at relatively high rate of 1 CmA at 25° C., the discharge capacity of the examples were larger those of the comparative examples. Further, when charge/discharge cycles were subsequently conducted at 1 CmA with the temperature changed to 0° C. from the 21st to the 40th cycles, large discharge capacities were exhibited by the examples, but only very low capacities or no capacities were exhibited by the comparative examples. From the above results, a battery employing a nonaqueous electrolyte according to the invention exhibits excellent high-rate charge/discharge characteristics, and is excellent in low temperature charge/discharge performance.

1. An electrolyte solution for an electrochemical energy device, comprising:
(a) a supporting electrolyte salt; and
(b) a solvent composition comprising: (1) at least one cyclic carbonic acid ester solvent; and (2) at least one fluorine-containing solvent having a boiling point of at least 80° C. and selected from among the following chemical formulas (i) to (iii):
(i) R₁—O—R_{f1}
where R₁ represents a linear, branched or cyclic C₁-C₁₂ alkyl, aryl or alkenyl group; and R_{f1} represents an at least partially fluorinated linear, branched or cyclic C₅-C₁₂ alkyl, aryl or aklenyl group that may optionally further contain one or more ether-bound oxygen atoms provided that where R_{f1} contains one or more oxygen atoms it contains at most two hydrogen atoms; with the proviso that when the solvent composition comprises only a fluorine containing solvent of the formula (i) the solvent composition does not also contain difluoroethylene carbonate;
ii R₂—O—(R_{f2}—O)ₚ—(R_{f3}—O)_{q}—R₃
where R₂ and R₃ each independently represent a linear or branched, non- or partially fluorinated C₁-C₁₂ alkyl group; R_{f2} and R_{f3} each independently represent a linear, branched or cyclic C₁-C₁₀ fluorinated alkylene group; and p and q are independently 0 or an integer from 1-10 with the proviso that p and q are not both 0 at the same time; and
iii A—(O—R_{f4})ₘ
where each R_{f4} independently represents an at least partially fluorinated linear, branched or cyclic C₂-C₉ alkyl, aryl or alkenyl group that may optionally include one or more ether-bound oxygen atoms and/or a halogen atom other than fluorine; A is a C₁-C₈ di- to tetravalent linear, branched or cyclic hydrocarbon group that may optionally contain one or more ether-bound oxygen atoms; and m is an integer from 2-4 with the proviso that when m is 2 then R_{f4} is perfluorinated or A is non-linear or both R_{f4} is perfluorinated and A is non-linear;
wherein said (a) supporting electrolyte salt is present in an amount of about 0.1-2 mol per liter of said (b) solvent composition, and said (b) solvent composition contains said (1) cyclic carbonic acid ester solvent at greater than 0 and less than about 90 vol % and said (2) fluorine-containing solvent at greater than 0 and no greater than about 80 vol %.

2. The solution of claim 1 wherein the supporting electrolyte salt includes an inorganic lithium salt at a concentration of less than about 0.1 mol/L and wherein the solvent composition further comprises at least one aprotic solvent other than a cyclic carbonic acid ester at a concentration of less than about 80 vol %.

3. The solution of claim 1 wherein the supporting electrolyte salt includes an inorganic lithium salt at a concentration of at least about 0.1 to about 2 mol/L as all or part of said lithium salt supporting electrolyte and wherein the solvent composition further comprises at least one aprotic solvent other than a cyclic carbonic acid ester at 10 vol % or greater and less than 80 vol %.

4. The solution of claim 3 wherein said aprotic solvent other than a cyclic carbonic acid ester include at least one linear carbonic acid ester represented by the general formula RₓOCOOR_{y}, where Rₓ and R_{y} are the same or different and independently represent a straight-chain or branched C₁-C₄ alkyl group.

5. A solution according to claim 1 wherein the solvent composition comprises a cyclic carbonic acid ester solvent selected from the group consisting of ethylene carbonate, propylene carbonate, butylenes carbonate, vinylene carbonate, vinylethylene carbonate, and mixtures thereof.

6. A solution according to claim 1 wherein the halogenation ratio of the fluorine-containing solvent having a boiling point of at least 80° C. is at least 0.50 and no greater than 0.85.

7. The solution of claim 6 wherein the fluorine-containing solvent having a boiling point of at least 80° C. is selected from the group consisting of:
C₆F₁₃—O—CH₃;
C₆F₁₃—O—C₂H₅;
CH₃—O—C₆F₁₂—O—CH₃;
CH₃—O—C₃F₆—O—C₃F₆—O—CH₃;
CF₃CFHCF₂—O—CH₂CH(CH₃)—O—CF₂CFHCF₃;
H(CF₂)₈CH₂—O—CH₃;
CF₃CFHCF₂—O—CH₂CH(—O—CF₂CFHCF₃)CH₂—O—CF₂CFHCF₃;
C(CH₂—O—CF₂CFHCF₃)₄;
CH₃C(CH₂—O—CF₂CFHCF₃)₃;
C₄F₉—O—CH₂CH₂—O—C₄F₉; and mixtures thereof.

8. A lithium secondary battery comprising a positive electrode, a negative electrode and an electrolyte solution according to claim 1.

9. A lithium secondary battery according to claim 8 wherein the positive electrode comprises a composite metal oxide composed of lithium and one or more transition metal elements.

10. A lithium secondary battery according to claim 9 wherein the negative electrode comprises at least one active substance selected from the group consisting of carbon materials, lithium, lithium-containing alloys and compounds which alloy with lithium.

11. A lithium secondary battery according to claim 10 wherein the negative electrode comprises lithium.

12. A lithium secondary battery according to claim 8 wherein charge and/or discharge is carried out with a current value of 1.0 CmA or greater as the maximum current value for charge and/or discharge, where CmA represents the smaller capacity from among the positive electrode capacity and the negative electrode capacity as calculated from the weight of the electrode active substance used in said lithium secondary battery.
